(19) United States
(12) Patent Application Publication
(10) Pub. No.: US 2020/0359829 A1
(43) Pub. Date: Nov. 19, 2020

(54) DEVICES AND METHODS FOR BREWING BEVERAGES

(71) Applicant: INNOVATIVE BREWING, LLC, Branford, CT (US)

(72) Inventor: David Y. LIGHT, Branford, CT (US)

(21) Appl. No.: 16/643,450

(22) PCT Filed: Aug. 31, 2018
(86) PCT No.: PCT/US2018/049254

§ 371 Date: Feb. 28, 2020

Related U.S. Application Data
(60) Provisional application No. 62/552,894, filed on Aug. 31, 2017.

(51) Int. Cl. A47J 31/42; A47J 42/50

(52) U.S. Cl. CPC A47J 31/42; A47J 31/4407; A47J 42/50

(57) ABSTRACT

The present disclosure generally relates to devices and methods for brewing beverages. More specifically, aspects of the present disclosure include devices suitable for brewing coffee from coffee beans which have been ground by the device using a wet grinding process, and methods of brewing coffee using such a device.

### BACKGROUND

There are many devices for brewing coffee. In a typical consumer-grade coffee making device, the user loads coffee grounds into a container in the device, and hot water is contacted with the coffee grounds such that water soluble components from the coffee grounds are extracted by the water. The coffee grounds are filtered from the mixture, resulting in hot coffee.

Traditional drip-based coffee makers typically comprise a filter basket that receives a coffee filter, ground coffee and water. The filter basket normally includes an outlet opening disposed in the center of the basket. Hot water is introduced into the top of the filter basket and contacts the coffee grounds such that water soluble components from the coffee grounds are extracted by the water, and exits through the outlet opening as a beverage (i.e., coffee), while the remaining coffee grounds are filtered from the mixture by the filter basket.

Conventional drip-based methods can produce a hot beverage within minutes. However, this technique typically fails to extract poorly soluble fats, fatty acids and other lipid-based compounds present in coffee beans. Solubility/extraction of poorly soluble compounds is often enhanced at higher temperatures, but the limited steeping time and structure of drip-based brewing devices is normally unfavorable for extraction of these compounds, resulting in limited or undetectable amounts of these compounds in coffee produced using conventional drip-based methods.

French press coffee brewing devices typically include a cylindrical glass container with a plunger that slides vertically along the central axis of the container. The head of the plunger includes a mesh filter. To make a pot of coffee, the plunger is removed from the container and coarse grounds are placed in the bottom of the container. Hot water is then added and stirred with the grounds. The coffee grounds are then allowed to steep for an appropriate length of time in order to allow extractable components to be extracted by the hot water. Finally, the plunger is depressed, collecting the free-floating grounds at the bottom of the container. Water and water extractable components from the coffee grounds pass through the filter. The resulting coffee beverage is normally served directly from the container. Coffee produced using the French press method is considered by some to be superior to drip-based brewing. However, conventional French press methods are only capable of extracting a very small amount of oil from coffee beans, limiting the range of taste and aroma profiles of beverages brewed using this method.

The structure of the conventional French press device is not ideal in that coffee grinds are collected by the plunger at the bottom of the steeping vessel. As a result, the steeping process cannot be terminated unless all of the coffee beverage in the vessel is poured out (i.e., to allow the user to remove the grinds collected at the bottom of the vessel). As a result, users cannot brew a batch of French press coffee, dispense a portion or single serving of the brewed beverage and then store the remaining coffee in the vessel because steeping will continue in the interim. Over-steeped coffee grinds typically produce a poor quality coffee beverage. French press coffee may also have an undesirable chalky taste profile in some instances due to poor filtering and/or use of the device with coffee that has been grounds too finely.

Coffee may also be produced using a cold brew process, which typically involves steeping coffee grinds in water for a prolonged period of time (e.g., ˜14-18 hours) at room temperature or a chilled temperature, and then separating the grinds from the resulting coffee beverage using a filter. The extended steeping time used by cold brew protocols allows one to brew a cup of coffee without the use of hot water which would otherwise change the flavor profile, resulting in a beverage with a unique extraction profile compared to standard drip-based brewing methods. Cold brew coffee has become increasingly popular in recent years, at least partially due to the perception by many users that cold brew coffee has improved flavor and aroma profiles compared to conventional coffee. However, adoption and commercialization of cold brew methods has been limited due to the long steeping time required by this method (e.g., users must plan ahead by ˜14 hours). As a result, cold brew methods have failed to supplant conventional drip-based brewing.

In sum, while methods of brewing coffee using drip-based, French press, and cold brew devices may be adequate for brewing a traditional cup of coffee, they suffer various limitations. For example, standard drip-based brewing techniques are fast but are often unable to extract a substantial portion of the desirable organic compounds present in coffee beans, e.g., drip-based methods typically fail to extract any measurable amount of oil from the coffee and the high heat required by this method may worsen the taste of the resulting beverage. French press methods are capable of extracting a small portion of the oil contained in the coffee beans but also require high heat which may negatively impact the flavor of the coffee, and also require substantial manual preparation by the user (a user must grind beans, heat water, mix the grinds and water, and filter the resulting coffee beverage). Cold brew methods typically fail to extract a substantial amount of the oil and other poorly soluble (or extractable) compounds in coffee and also require a sizable investment of time, e.g., 12-16 hours. None of these existing devices or methods provides fast brewing, high oil extraction and the option to completely avoid heat damage.

### SUMMARY

The present disclosure provides devices and methods for brewing beverages that may avoid one or more of the limitations of traditional methods of brewing beverages, such as high temperature drip-based, French Press and/or cold brewing methods. For example, the devices and methods described herein can provide one or more of the following advantages compared to such traditional systems and methods:
an all-in-one system for grinding and brewing beverages that does not, for example, require a user to separately heat water after grinding or filtering particulates;
an expanded palette of flavor profiles, an improved composition, color, and/or properties, and/or an enhanced extraction of beneficial organic compounds, resulting in unique, enhanced and/or alternative flavor and/or aroma profiles;
an increased concentration and/or amount of beneficial compounds;
enhanced extraction of fats, fatty acids and other poorly soluble compounds;
an improved filtration process that results in reduced particulate levels;
a removable grinder assembly adapted to fit within a beverage brewing device;
ease-of-use (e.g., easy to measure amount of coffee, easy to clean, customizable features such as coffee flavors, brew intensities, and temperatures);
an enhanced user experience that permits, for example, the user to visualize active grinding and brewing; and
a full brewing process with substantially no exposure to oxygen and thus prevents oxidative damage (which degrades flavor).

These and other features that improve upon currently available systems for brewing beverages are described in detail herein.

Disclosed herein are various devices and methods that may be used to brew a beverage, and, in particular, devices and methods for brewing coffee using a wet grinding process. The coffee brewing devices and methods disclosed herein, in some aspects, produce coffee that may be enriched with a higher concentration of beneficial compounds such as antioxidants and polyunsaturated fatty acids compared to traditional drip-based and French press coffee brewing devices. In addition to providing additional unique extraction profiles, aspects of the disclosure also may provide efficient coffee brewing devices for consumer and commercial use.

In some aspects, various pods adapted for use with a beverage brewing device are disclosed. Some implementations of the pod may include, for example, but not limited hereto: an upper wall; a lower wall; one or more side walls connecting the upper wall and the lower wall to form a compartment; a grinder attached to an inner surface of the compartment and adapted to grind edible material; wherein at least a portion of the upper wall, the lower wall, or the one or more side walls comprises a filter adapted to allow fluid communication through the pod.

In some aspects, the grinder is a burr grinder or a rotary grinder, optionally adapted to grind coffee beans. The pod may be configured to allow detachment of the filter from the container (e.g., the filter is attached to the container by at least one hinge or clasp).

An outer surface of the pod may be adapted (or shaped) to attach to a surface of a container and the container may comprise one or more of the following, for example, but not limited hereto: a fluid reservoir; a motor configured to drive the grinder; a switch configured to activate the grinder; and/or a power source configured to power the grinder. The outer surface of the pod may be adapted (or shaped) to attach to a surface of a container, the container comprises a fluid reservoir and is attached to a base, and the base may comprise one or more of the following, for example, but not limited hereto: a motor configured to drive the grinder; a switch configured to activate the grinder; and/or a power source configured to power the grinder.

In some aspects, the pod's filter may comprise, for example, but not limited hereto: a mesh filter; a solid support having one or more pores; and/or a fabric configured to allow fluid communication across the fabric while retaining edible material grinds. The filter, solid support, and/or fabric may, for example, prevent particulates from being deposited in a beverage. The filter, solid support, and/or fabric may have pores with a pore size of 10 μm to 1,000 μm or any size within this range (e.g., 10 μm, 25 μm, 50 μm, 100 μm, 250 μm or 500 μm). In some aspects one or more filters incorporated into a pod may have a pore size ranging from: 10-50 μm, 10-100 μm, 10-250 μm, 10-500 μm, 20-60 μm, 30-70 μm, 40-80 μm, 50-90 μm, 60-100 μm, 100-200 μm, 200-300 μm, 300-400 μm, 400-500 μm, 500-600 μm, 600-700 μm, 700-800 μm, 800-900 μm, 900-1,000 μm, or a range bounded by a combination of any two endpoints selected from the preceding ranges. In some aspects, any combination or arrangement of filter densities may be selected for the top, bottom and sidewall(s) of a pod, or any portions thereof

The pod may further comprise, for example, but not limited hereto: a cap adapted to attach to the pod, the cap being adapted to define an upper wall of the pod. In some aspects, the grinder in the pod may comprise one or more of the following, for example, but not limited hereto: a pumping burr grinder; one or more interchangeable blades; or one or more blades adapted to provide simultaneous grinding and mixing; a grinding element having at least one flat blade and at least one bent blade; and/or a grinding element having at least one flat blade, wherein the flat blade is substantially vertical or horizontal. In some aspects, the grinder may also comprise a “U”-shaped blade adapted to provide force to direct liquid laterally through at least one filter of the pod. In other aspects, the grinder is configured to perform filtration by repeatedly circulating liquid through at least one filter of the pod.

The disclosure also provides various beverage brewing devices compatible with the pod discloser herein. For example, such beverage brewing devices may include but are not limited to: any pod described herein; a container, having a top end and a bottom end; wherein the pod is configured to attach to an inner surface of the bottom end of the container (and optionally, the top end); and a base adapted to attach to the bottom end of the first container, comprising a motor configured to operate the grinder.

In some aspects, the beverage brewing device comprises, for example, but not limited hereto: any pod described herein; a first base, adapted to allow the pod to attach to an upper surface of the first base; a second base, adapted to allow the first base to attach to an upper surface of the second base, wherein the second base comprises a power supply configured to power the grinder and a motor configured to operate the grinder; a container, having a top end and a bottom end, wherein at least a portion of the bottom end comprises a filter adapted to allow fluid communication between the container and the pod; wherein the pod is configured to attach to an inner surface of the bottom end of the container.

In some aspects, the beverage brewing device comprises, for example, but not limited hereto: any pod described herein; a container, having a top end and a bottom end; wherein the container is configured to allow attachment of the pod to an inner surface of the bottom end of the container; and a base adapted to attach to the bottom end of the container, comprising a motor configured to operate the grinder; and optionally, further comprises a scaffold extending along a vertical axis of the container, adapted to attach to the pod. Devices according to some embodiments may include a base and/or the container which comprises at least one of the following: a heating element adapted to heat or maintain the temperature of a liquid stored in the container; a switch configured to activate the grinder; and/or a power supply configured to power the grinder.

Some devices may include a container comprising a fluid reservoir, where the device is configured to enable or block fluid communication between the container and the fluid reservoir of the second container in response to user input. In other aspects, the device further comprises a scaffold element positioned within this container (e.g., to isolate coffee beans and partially ground coffee beans above a given size threshold). In some aspects, the scaffold comprises a heating element adapted to heat or maintain the temperature of a liquid stored in the container. The scaffold used on any of the devices disclosed herein may be further adapted to attach to a lid of the device, which may in turn be detachable.

Additional aspects of the disclosure include methods of brewing a beverage, and in particular methods of brewing a coffee beverage. A method of brewing a beverage may comprise, for example, but is not limited hereto: placing an edible material in any of the pods described herein; submerging the pod in a liquid, wherein the liquid is sufficient to fully or partially submerge the edible material; grinding the edible material; and generating a beverage by steeping the ground-up edible material(s) in the liquid. In some implementations, the edible material may comprise a plurality of coffee beans that may be ground and used to brew a coffee beverage alone or in combination with one or more additional edible materials (e.g., flavoring agents or enhancers, nutritional or dietary supplements, meal replacement components, fruit). In some aspects, the ground-up coffee is steeped for less than 5, 10, 15, 20, 25 or 30 minutes, or steeped for a range of time (e.g., 1-5 minutes, 5-10 minutes, 10-20 minutes or any combination of minimum and maximum values within these ranges). In some aspects, the ground-up coffee may be steeped at a temperature of 0-25° C., 80-100° C., or at any temperature within the range of 0-100° C. suitable for producing a given beverage.

Another exemplary method of brewing a coffee beverage may comprise, for example, but is not limited hereto: placing an amount of coffee beans in any of the pods described herein; placing the pod within a container; adding hot or cold water to the container; submerging the grinding pod in the hot or cold water in the container; generating coffee grinds by grinding the coffee beans using the grinder in the pod, wherein the grinding is subject to one or more selected parameters; and optionally steeping the coffee grinds in the hot or cold water. The approximate amount of coffee beans placed in the pod may be, for example, any one of the following: 20 g, 5-20 g, 10-30 g, 15-40 g, 20-50 g or >50 g. In some aspects of the brewing methods described herein, the pod may be attached to a scaffold prior to placing the pod in the container, wherein the scaffold is attached to an upper surface or a lower surface of the pod. In some implementations, the volume of water added to the container is: 100-200 mL, 201-300 mL, 301-400 mL, 401-500 mL or >500 mL. The one or more selected parameters used for the brewing process may include, for example, but are not limited hereto: a motor rotation speed parameter, a grinder run time parameter; a temperature parameter and/or a post-grinding steeping time parameter. Additional parameters may include, for example, blade shape/type and filter size (e.g., minimum or maximum aperture size). The coffee grinds may be steeped in the hot or cold water, for example, for any one of the following durations of time: ≤5 minutes, 5-10 minutes, 10-20 minutes, 20-30 minutes or ≥30 minutes. The temperature of the water added to the container is also variable and, for example, may fall within any of the following ranges: 0-5° C., 5-10° C., 10-20° C., 20-30° C., 30-50° C., 50-80° C. or 80-100° C. In any of the methods of making coffee described herein, the method may be performed using 6% w/v ratio of coffee beans or grounds to water.

In still further aspects, the disclosure provides various coffee compositions, such as coffee compositions prepared according to or with the methods and devices described herein. Coffee compositions described herein may include, for example, one or more of the following: at least 0.25% total fat, at least 0.1% saturated fat, and/or at least 0.1% polyunsaturated fat. In some aspects, the coffee composition may have at least 0.10%, 0.15%, 0.20%, 0.30%, 0.35%, 0.40%, 0.45% or 0.50% total fat, or a total fat concentration within the range of 0.10%-0.50%, 0.20%-0.40%, 0.25%-0.35%, or any combination of minimum and maximum values therein. In some aspects, the coffee composition may have at least 0.05%, 0.15%, 0.20%, 0.25%, 0.30%, 0.35%, 0.40%, 0.45% or 0.50% saturated fat, or a saturated fat concentration within the range of 0.05%-0.50%, 0.1%-0.40%, 0.15%-0.35%, or any combination of minimum and maximum values therein. In some aspects, the coffee composition may have at least 0.05%, 0.15%, 0.20%, 0.25%, 0.30%, 0.35%, 0.40%, 0.45% or 0.50% polyunsaturated fat, or a polyunsaturated fat concentration within the range of 0.05%-0.50%, 0.1%-0.40%, 0.15%-0.35%, or any combination of minimum and maximum values therein.

Coffee compositions produced using the methods and devices disclosed herein may have, for example, a polyphenol concentration of ≥100 mg/100 ml, ≥125 mg/100 ml, ≥150 mg/100 ml, 50-250 mg/100 ml, 100-200 mg/100 ml, 125-175 mg/100 ml, or any integer value within these ranges. In other aspects, the coffee compositions has at least 65 mg/100 ml caffeine content. Coffee compositions produced using the methods and devices disclosed herein may also have, for example, a particulate concentration of ≤5 mg/mL, ≤6 mg/mL, ≤7 mg/mL, ≤10 mg/mL or a particulate concentration within the range of 3-7 mg/mL, 4-8 mg/mL, 3-9 mg/mL, 1-10 mg/mL, or any or any combination of minimum and maximum integer values within these ranges. In other aspects, the coffee composition, generated by coffee grounds, has been exposed to oxygen only at levels of <1%.

In any of the coffee compositions described herein, the composition comprises coffee beans ground and brewed in water with an 6% w/v ratio of coffee beans or grounds to water.

Additional beverage brewing devices according to an aspect of the disclosure may include a first container, having a top end and a bottom end; a second container adapted to attach to the bottom end of the first container, comprising a grinder and a filter; wherein the grinder is positioned within the second container; and a base adapted to attach to the bottom end of the first container, comprising a motor configured to operate the grinder.

In some aspects, the grinder is a burr grinder or a rotary grinder, may comprise one or more blades, and/or may be adapted to grind coffee beans. In some aspects, the grinder comprises a “U”-shaped blade adapted to provide sufficient force to laterally direct liquid through at least one filter of the pod. In some aspects, the filter comprises a metallic sieve having one or more openings adapted to allow a liquid to pass through the filter, and/or is attached to the second container by at least one hinge or clasp. In some aspects, the filter is a mesh filter attached to the second container by at least one hinge or clasp. In other aspects, the device comprises a grinder configured to perform filtration by repeatedly circulating liquid through at least one filter of the pod. In other aspects, the first container is non-circular and adapted such that water emanating from a second container will have variable path lengths to the walls of the first container. In some aspects, the second container is a pod or canister.

Beverage brewing devices according to another aspect of the disclosure may include, for example, a first container, having a top end and a bottom end; wherein at least a portion of the bottom end comprises a filter; a base adapted to attach to the bottom end of the first container, comprising a motor; and a second container comprising a top end, a bottom end, and a grinder positioned within the second container and configured to be operated by the motor; wherein the bottom end of the second container is adapted to attach to the base at a position.

In some aspects, the base further comprises a power supply connected to the motor; or is connectable to an external power supply capable of powering the motor. In some aspects, the second container is a pod or canister, and/or the grinder is a burr grinder or a rotary grinder, which may adapted to grind coffee beans. In some aspects, the filter comprises a metallic sieve having one or more openings adapted to allow a liquid to pass through the filter.

Beverage brewing devices according to another aspect of the disclosure may include, for example, a container, having an top end and a bottom end; a handle attached to an outside surface of the container and comprising a switch; a grinder, attached to an inside surface of the container at the bottom end; a repositionable filter attached to an inside surface of the container, configured to move into an open position or a closed position in response to operation of the switch; wherein the closed position prevents fluid communication between the container and the compartment; and a base adapted to attach to the bottom end of the container, comprising a motor configured to operate the grinder.

In some aspects, the device further includes, for example, means for locking the filter in a closed position, wherein the means for locking is configured to unlock in response to operation of the switch. In some aspects, the repositionable filter is a mesh filter attached to the inside surface of the container by at least one hinge, and/or comprises a metallic sieve having one or more openings adapted to allow a liquid to pass through the filter. In some aspects, the grinder is a burr grinder or a rotary grinder, which may be adapted to grind coffee beans. In some aspects, the base further comprises a power supply connected to the motor; or is connectable to an external power supply capable of powering the motor.

Beverage brewing devices according to another aspect of the disclosure may include, for example, a first container, having a top end and a bottom end; a second container, having a top end, a bottom end, and a side wall; wherein at least a portion of the side wall, the bottom end, and/or top end comprises a filter; a grinder, attached to the second container at the bottom end; a partition positioned within the second container, which defines an upper chamber and a lower chamber, wherein the lower chamber contains the grinder; and a base adapted to attach to the bottom end of the second container, comprising a motor configured to operate the grinder.

In some aspects, the filter comprises a majority of the surface area of the second container. In some aspects, the partition is adapted to prevent suction of air into the grinder during operation of the grinder. In some aspects, the filter is structured as a cylinder or a conical cylinder. In other aspects, the filter comprises a metallic sieve having one or more openings adapted to allow a liquid to pass through the filter. In some aspects, the second container further comprises at least one attachment point configured to fasten or secure the filter in place. In some aspects, the base further comprises a power supply connected to the motor; or is connectable to an external power supply capable of powering the motor. In some aspects, the grinder is a burr grinder or a rotary grinder, which may be adapted to grind coffee beans.

Beverage brewing devices according to another aspect of the disclosure may include a beverage brewing device, comprising: a container, having a top end and a bottom end; a grinder assembly configured to fit within the container, comprising: an upper compartment having a top end, a bottom end, and a side wall, wherein at least a portion of the bottom end of the upper compartment comprises a filter, grating or valve and the sidewalls allow water to flow through into the container; a detachable lower compartment having a bottom end and a sidewall, wherein at least a portion of the bottom end and/or side wall comprises a filter; a grinder, attached to the lower compartment at the bottom end; and a base adapted to attach to the bottom end of the container, comprising a motor configured to operate the grinder.

In some aspects, the device comprises a heating element integrated into the device. In other aspects, the heating element is integrated into a base, compartment or the container of the device, and/or the heating element is configured to heat and/or maintain the temperature of a liquid stored in the container or compartment of the device.

In other aspects, the grinder comprises one or more of the following: a pumping burr grinder; one or more interchangeable blades; one or more blades adapted to provide simultaneous grinding and mixing; a grinding element having at least one flat blade and at least one bent blade; and/or a grinding element having at least one flat blade, wherein the flat blade is substantially vertical or horizontal. In other aspects, the grinder comprises a “U”-shaped blade adapted to provide force to direct liquid through at least one filter of the device.

The disclosure also provides for a grinder assembly adapted to fit within a beverage brewing device, comprising a container adapted to store one or more edible materials (e.g., coffee beans); and a grinder, wherein the grinder is attached to an inside surface of the container. In other aspects, the container comprises a sealed bottom end, a side wall attached to the bottom end, and an open end; and the grinder is attached to the inner surface of the sealed bottom end of the container.

In still further aspects of the disclosure, methods of brewing coffee using any of the brewing devices disclosed herein are provided. For example, an exemplary method of brewing coffee may include providing a coffee brewing device comprising: a first container, having a top end and a bottom end; a second container adapted to attach to the bottom end of the first container, comprising a grinder and a filter; wherein the grinder is positioned within the second container; and a base adapted to attach to the bottom end of the first container, comprising a motor configured to operate the grinder; placing a plurality of coffee beans within the second container; adding liquid to the first container sufficient to fully or partially submerge the coffee beans in the second container; and generating coffee by grinding the coffee beans and allowing soluble and/or extractable components of the coffee beans to dissolve or form an emulsion in the liquid.

In other aspects, methods of brewing coffee include providing a coffee brewing device according to any of the various configurations described herein, adding sufficient liquid to a container or compartment of the device to fully or partially submerge the coffee beans, and generating coffee by grinding the coffee beans and allowing extractable components of the coffee beans to dissolve or form an emulsion in the liquid.

In some aspects, the liquid added to the container is at least: 0° C. to 100° C., 0° C. to 20° C. or 80° C. to 100° C., when added to the container.

In some aspects, the extractable components of the coffee beans are allowed to dissolve or form an emulsion in the liquid over a period of at least: 5 to 10 minutes, 10 to 30 minutes or 30 to 90 minutes.

In other aspects, the disclosure provides a method of brewing coffee, comprising: providing a coffee brewing device comprising a first container, having a top end and a bottom end; a second container adapted to attach to the bottom end of the first container, comprising a grinder and a filter; wherein the grinder is positioned within the second container; and a base adapted to attach to the bottom end of the first container, comprising a motor configured to operate the grinder; placing a plurality of coffee beans within the second container; adding liquid to the first container sufficient to fully or partially submerge the coffee beans in the second container; and generating coffee by grinding the submerged coffee beans and allowing soluble and/or extractable components of the coffee beans to dissolve or form an emulsion in the liquid. In further aspects, the liquid added to the container is at least 0° C. to 100° C.; 0° C. to 20° C.; or 80° C. to 100° when added to the container. In other aspects, the extractable components of the coffee beans are allowed to dissolve and/or form an emulsion in the liquid over a period of at least 0.5 to 10 minutes; 10 to 30 minutes; or 30 to 90 minutes.

In yet other aspects, the disclosure provides a method of brewing coffee comprising at least partially submerging coffee beans in container comprising water, wherein there is an approximately 6% w/v ratio of coffee beans to water; and grinding the coffee beans to obtain coffee, wherein the coffee comprises at least 0.25% total fat, at least 0.1% saturated fat, at least 0.1% polyunsaturated fat, at least 140 mg/100 ml polyphenol content, at least 65 mg/100 ml caffeine content, a substantially brown color, and/or a particulate concentration of ≤10 mg/mL. In other aspects, the ratio of coffee beans to water are at a ratio other than 6% but the relationship of the ratio to total fat, saturated fat, polyunsaturated fat, polyphenol content, caffeine content, and/or a particulate concentration remains linear. In other aspects, the water has a temperature of 0 to 25° C., the coffee is brewed within 15, or the water has a temperature of 0 to 25° C. and the coffee is brewed within 15 minutes.

Details of one or more implementations of the subject matter described in this specification are set forth in the accompanying drawings and the description below. Other features, aspects, and advantages will become apparent from the description, the drawings, and the claims.

### BRIEF DESCRIPTION OF THE DRAWINGS

The accompanying drawings, which are incorporated into and constitute a part of this specification, illustrate one or more example aspects of the invention and, together with the detailed description, serve to explain their principles and implementations. In several of the figures, a hatched pattern is used to indicate the presence of a liquid within implementations of a beverage brewing devices according to the disclosure.

FIG. 1A is a cross-sectional view of a coffee brewing device according to an aspect of the disclosure.

FIGS. 1B, 1C and 1D are cross-sectional views of three examples of second containers 102 compatible with the coffee brewing device shown in FIG. 1A and various other implementations disclosed herein.

FIG. 2 is a cross-sectional view of a coffee brewing device according to another aspect of the disclosure.

FIG. 3 is a cross-sectional view of a coffee brewing device according to another aspect of the disclosure.

FIG. 4 is a cross-sectional view of a coffee brewing device according to another aspect of the disclosure.

FIG. 5A is a cross-sectional view of a container 501 and base 502 subassembly of a coffee brewing device according to another aspect of the disclosure, in a disassembled state.

FIGS. 5B and 5C is a cross-sectional views of a grinding assembly 508 compatible with the container 501 and base 502 subassembly of FIG. 5A, in a disassembled state. This grinding assembly 508 is also compatible with various other implementations disclosed herein.

FIG. 5D is a cross-sectional view of a coffee brewing device produced by combining the container 501 and base 502 of FIG. 5A with the grinding assembly of FIG. 5B.

FIG. 5E is a cross-sectional view of the assembled coffee brewing device of FIG. 5C, in a ready to use state, filled with water and loaded with coffee beans.

FIG. 5F is a cross-sectional view of the assembled coffee brewing device of FIG. 5C during operation, annotated to illustrate an exemplary fluid path.

FIG. 6A is a cross-sectional view of a container 601 and base 602 subassembly of a coffee brewing device according to another aspect of the disclosure, in a disassembled state.

FIG. 6B is a cross-sectional views of a grinding assembly 608 compatible with the container 601 and base 602 subassembly of FIG. 6A, in a disassembled state. This grinding assembly 608 is also compatible with various other implementations disclosed herein.

FIG. 6C is a cross-sectional view of a coffee brewing device produced by combining the container 601 and base 602 of FIG. 6A with the grinding assembly of FIG. 6B.

FIG. 6D is a cross-sectional view of the assembled coffee brewing device of FIG. 6C during operation, annotated to illustrate an exemplary fluid path.

FIG. 7A is a cross-sectional view of a container 701 and base 702 subassembly of a coffee brewing device according to another aspect of the disclosure, in a disassembled state.

FIG. 7B is a cross-sectional views of a grinding assembly 708 compatible with the container 701 and base 702 subassembly of FIG. 7A, in a disassembled state. This grinding assembly 708 is also compatible with various other implementations disclosed herein.

FIG. 7C is a cross-sectional view of a coffee brewing device produced by combining the container 701 and base 702 of FIG. 7A with the grinding assembly of FIG. 7B, in a ready to use state, filled with water and loaded with coffee beans.

FIG. 7D is a cross-sectional view of the assembled coffee brewing device of FIG. 7C during operation, annotated to illustrate an example of a fluid path.

FIG. 8A is a cross-sectional view of a container 801 and base 802 subassembly of a coffee brewing device according to another aspect of the disclosure, in a disassembled state.

FIG. 8B is a cross-sectional views of a grinding assembly 808 compatible with the container 801 and base 802 subassembly of FIG. 8A, in a disassembled state. This grinding assembly 808 is also compatible with various other implementations disclosed herein.

FIG. 8C is a cross-sectional view of a coffee brewing device produced by combining the container 801 and base 802 of FIG. 8A with the grinding assembly of FIG. 8B, in a ready to use state, filled with water and loaded with coffee beans.

FIG. 8D is a cross-sectional view of the assembled coffee brewing device of FIG. 8C during operation, annotated to illustrate an example of a fluid path.

FIG. 9A is a cross-sectional view of a container 901 subassembly of a coffee brewing device according to another aspect of the disclosure, in a disassembled state.

FIG. 9B is a cross-sectional view of a scaffold 904 and filter 905 subassembly compatible with the container 901 subassembly of FIG. 9A, in a disassembled state.

FIG. 9C is a cross-sectional view of a lid 906 and grinder mount 909 subassembly compatible with the subassemblies of FIGS. 9A and 9B, in a disassembled state.

FIG. 9D is a cross-sectional view of a detachable grinder 910 compatible with the subassemblies of FIGS. 9A-9C, in a disassembled state.

FIG. 9E is a cross-sectional view of a coffee brewing device produced by combining the subassemblies of FIGS. 9A-9D, loaded with coffee beans.

FIG. 10A is a cross-sectional view of an exemplary grinding assembly that may be used as part of the coffee brewing devices disclosed herein.

FIG. 10B is a cross-sectional view of another example of a grinding assembly that may be used as part of the coffee brewing devices disclosed herein.

FIGS. 11A and 11B are cross-sectional views of another example of a grinding assembly that may be used as part of the coffee brewing devices disclosed herein.

FIGS. 12A and 12B are cross-sectional views of another example of a grinding assembly that may be used as part of the coffee brewing devices disclosed herein.

FIG. 13A is a bar graph of differences in the polyphenol (antioxidant) content of coffee brewed using an example device according to the present disclosure compared to coffee brewed using a conventional drip-based brewing device.

FIG. 13B is a bar graph of differences in the total fat content of coffee brewed using an example device according to the present disclosure compared to coffee brewed using several conventional brewing devices and methods.

FIG. 13C is a bar graph of differences in the caffeine content of coffee brewed using an example device according to the present disclosure compared to coffee brewed using several conventional brewing devices and methods.

FIG. 13D is a bar graph of differences in the fatty acid profile of coffee brewed using an example device according to the present disclosure compared to coffee brewed using several conventional brewing devices and methods.

FIG. 14A is a perspective view of an example of a grinding assembly that may be used as part of the coffee brewing devices disclosed herein.

FIG. 14B is a side view of an example of various scaffolds that may be used as part of the grinding assemblies and coffee brewing devices disclosed herein.

FIGS. 15A-B are perspective views of an example of a coffee brewing device according to another implementation of the disclosure in an assembled state (FIG. 15A) and a disassembled state (FIG. 15B).

FIG. 15C is a side view of the implementation of FIGS. 15A-B.

FIGS. 16A-C are perspective views of an example of a coffee brewing device according to another implementation of the disclosure in an assembled state (FIG. 16A) and a disassembled state (FIGS. 16B and C).

FIGS. 17A and B are top views of two alternative container configurations that may be used with any of the beverage brewing devices disclosed herein. In particular, FIG. 17A includes an oval outer container and FIG. 17B includes a triangular outer container.

### DETAILED DESCRIPTION

The disclosure provides devices and methods for efficiently producing beverages having improved properties compared to traditional brewing methods. In general, these devices provide an all-in-one grinding and brewing system that grinds edible material (e.g., coffee beans) or combinations of edible materials (e.g., coffee beans and one or more edible additives or flavorants such as cinnamon sticks, chocolate or spices) submerged or partially submerged in a liquid. It is understood that any edible material capable of being ground and brewed to form a beverage may be used. These devices and components thereof are provided herein, as well as methods of brewing beverages, and beverages obtained are provided.

Conventional drip-based coffee brewing at high temperatures is used to quickly brew a cup of coffee. However, drip-based methods typically fail to extract poorly soluble coffee compounds (e.g., fats, fatty acids and other compounds), and consequently fail to produce coffee having these compounds. On the other hand, French press methods are capable of extracting a small portion of the oil contained in the coffee beans but require high heat which may negatively impact the flavor of the coffee, and also require substantial manual preparation by the user (a user must grind beans, heat water, mix the grinds and water, and filter the resulting coffee beverage). Cold brew methods typically fail to extract a substantial amount of the oil and other poorly soluble (or extractable) compounds in coffee and also require a sizable investment of time, e.g., 12-16 hours. None of these existing devices or methods provides fast brewing, high oil extraction and the option to completely avoid heat damage.

Surprisingly, the present disclosure provides brewing methods and devices capable of producing coffee having an extraction profile similar to or better than known methods, quickly and without heat damage. A summary of selected differences between known coffee brewing methods and methods according to the present disclosure (“HydroGrind”) is provided by Table 1 below. Relative differences in properties or requirements are denoted by one or more “+” (positive) or “X” (negative) symbols. With respect to “dissolved content,” caffeine and anti-oxidant content were selected as representative proxies for evaluating this parameter.

TABLE 1
Relative Advantages of HydroGrind Coffee.

| | Oil | Dissolved | Heat | Prep and | Brew | Serial Cup | Oxygen |
|---|---|---|---|---|---|---|---|
| Method | Content | Content | Damage | Clean Time | Time | Serving | Exposure |
| Drip | X | + | X | + | + | + | X |
| French | ++ | ++ | X | X | + | X | X |
| Press | | | | | | | |
| Cold | + | + | + | + | XXX | + | X |
| Brew | | | | | | | |
| Hydro- | +++++ | +++ | + | + | + | + | + |
| Grind | | | | | | | |

The present disclosure provides methods of brewing coffee from whole coffee beans without any further intervention by the user (e.g., there is no need to heat water or filter the particulates afterwards, or to measure bean amounts or water levels). Relatively low particulate count is largely enabled by circulating pod filtration in some implementations and/or by the use of filters. The devices and methods also enable a wide variety of coffee flavors, brew intensities and temperatures by allowing easy user interfaces. The user can create a very wide variety of coffee flavors simply by changing grinding time, grinding speed, water temperature and blade/pod accessory. The devices and methods also allow ease of cleaning since majority of insoluble/non-extractable material is confined to the easy-to-handle container (or pod in some implementations).

Various aspects are now described with reference to the drawings, wherein like reference numerals are used to refer to like elements throughout. In the following description, for purposes of explanation, numerous specific details are set forth in order to promote a thorough understanding of one or more aspects. It may be evident in some or all instances, however, that any aspect described below can be practiced without adopting the specific design details described below. In other instances, well-known structures and devices are shown in block diagram form in order to facilitate description of one or more aspects. The following presents a simplified summary of one or more aspects in order to provide a basic understanding of the aspects. This summary is not an extensive overview of all contemplated aspects, and is not intended to identify key or critical elements of all aspects nor delineate the scope of any or all aspects.

### Grinding Pods

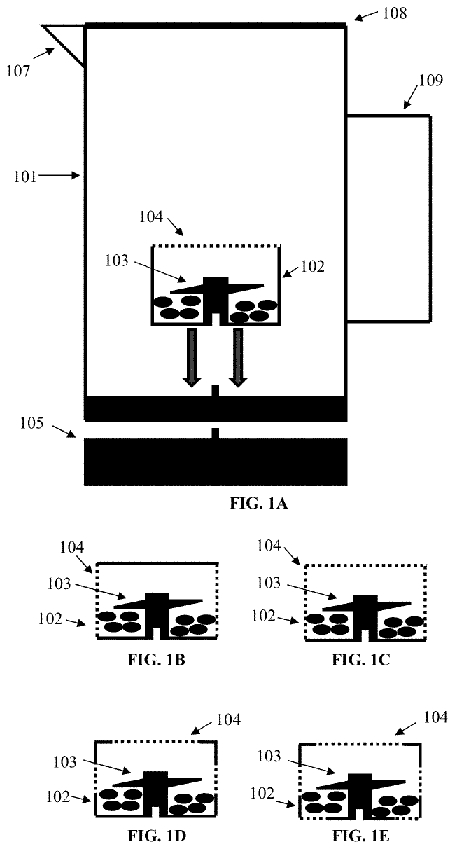

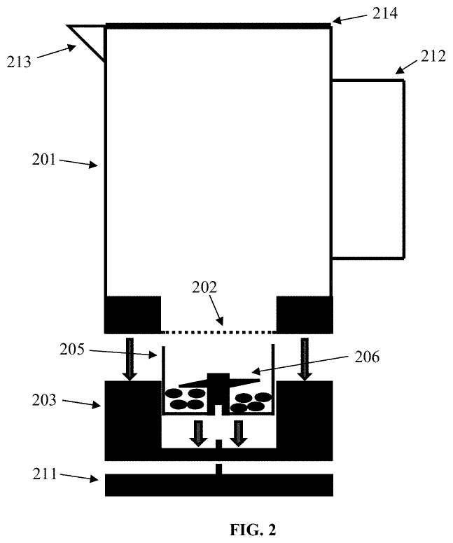

The present disclosure provides various beverage brewing devices and methods, and in particular devices and methods for brewing coffee. Many of the devices described herein utilize a grinding pod (in some contexts abbreviated as a “pod” or referred to more generally as a “container”) that may be attached to or inserted into another container that functions as a water reservoir. Pods may be structured, in some non-limiting examples, as a container, capsule, chamber, compartment or other enclosed vessel wherein at least one surface comprise a filter allowing liquid communication. FIGS. 1-10, 12, 13C, and 14 include different, non-limiting examples of pod structures and configurations, which are described throughout the disclosure, alone and in operation as a component of various exemplary beverage brewing devices. Although pods are often described in the devices and methods herein to provide additional context, it is understood that the pods themselves are also implementations of the present disclosure.

In some aspects, a pod adapted for use with a beverage brewing device may comprise: an upper wall; a lower wall; one or more side walls connecting the upper wall and the lower wall to form a compartment; a grinder attached to an inner surface of the compartment and adapted to grind an edible material; wherein at least a portion of the upper wall, the lower wall, or the one or more side walls comprises a filter adapted to allow fluid communication through the pod. The grinder may be a burr grinder or a rotary grinder, and in some implementations may be adapted to grind coffee beans.

One or more of the pod filters may be detachable or adjustable into an open or closed configuration (e.g., by a hinge or clasp). The pod may be a capsule or canister, or in some implementations an enclosed compartment formed from a scaffold. The outer surface of the pod may be adapted to attach to a surface of a container, wherein the container comprises one or more of a fluid reservoir, a motor configured to drive the grinder, a switch configured to activate the grinder, and/or a power source configured to power the grinder. In still further implementations, one or more of these components may be located instead on a base configured to attach to the container during operation of a beverage brewing device.

In some aspects, the grinding pod is adapted to attach to the inside of a container which stores the brewing liquid in a manner that allows the pod to be switched between a closed state which blocks fluid communication between the container and the pod (e.g., preventing or stopping the steeping process) and an open state allowing fluid communication between the container and the pod (e.g., allowing steeping to begin or continue). For example, the pod may be adapted to rotate between two configurations when attached, which open or block one or more openings in a side wall or other surface of the grinding pod. Configurations which incorporate this feature advantageously allow a user to store the grinding pod in the brewing device after brewing is complete by switching the pod to the closed position, providing convenient storage for the pod without over-steeping the brewed beverage.

The grinder within the pod may comprise one or more of the following: a pumping burr grinder, one or more interchangeable blades, one or more blades adapted to provide simultaneous grinding and mixing, a grinding element having at least one flat blade and at least one bent blade, and/or a grinding element having at least one flat blade, wherein the flat blade is substantially vertical or horizontal. The thickness and/or the angle of the grinding blade(s) may be adapted to grind edible material(s) (e.g., coffee beans) to a selected minimum or average particle size.

### Beverage Brewing Devices

FIG. 1A includes a coffee brewing device according to an aspect of the disclosure. In this example, a coffee brewing device 100 may include a first container 101, having a top end and a bottom end; a second container 102 adapted to attach to the bottom end of the first container, comprising a grinder 103 and a filter 104 wherein the grinder 103 is positioned within the second container 102; and a base 105 adapted to attach to the bottom end of the first container 101, comprising a motor configured to operate the grinder 103. In some aspects, devices according to FIG. 1A. may optionally include a spout 107, lid 108, and/or handle 109.

In some aspects, the filter 104 may be removable. The filter 104 may be attachable to the second container 102 by a hinge, clasp, or any other means for securing the filter 104 to the second container 102. The filter 104 may be constructed from metal, plastic, fabric, or any other suitable material and the pore size of the filter may vary depending on the size of the ground material used to prepare a beverage with the device. For example, the second container 102 may include a grinder 103 configured to finely grind coffee beans (or other materials), which may require that the filter 104 have a small pore size to isolate the ground coffee. Alternatively, the second container 102 may include a grinder 103 configured to coarsely grind coffee beans (or other materials), which may require that the filter 104 have a larger pore size.

In some aspects, devices according to this general design may be provided as a system comprising a first container 101 and base 105 and a plurality of second containers 102, each second container 102 having a grinder 103 configured to provide a different level of grinding. In some aspects, the grinder 103 is a burr grinder or a rotary grinder. In some aspects, the second container 102 is structured as a pod or canister.

The base 105 may include a motor 106 configured to drive the grinder 103 and an optional power supply 110 to power said motor 106. In some aspects, the power supply 110 comprises a battery 111. Alternatively, the motor 106 and/or the power supply may be connectable to an external power outlet. In some aspects, the motor 106 is powered by a battery included in the base 105.

In some aspects, the grinder 103 is activated by a switch positioned on the first container 101, on the base 105, or elsewhere on the coffee brewing device. The switch 112 may be manually controlled by a human operator (e.g., a push-button or toggle), subject to a mechanical or digital timer, or computer-controlled.

In some aspects, the device is configured to communicate wirelessly with a cellular phone, computer or other electronic device allowing a user to activate the grinder 103 or otherwise operate the device remotely. In some aspects, the device is configured to communicate with software running on a cellular phone or other mobile device which is able to schedule operation of the device (e.g., activating the grinder 103 at specific times set by a user).

In some aspects, the first container 101 or the base 105 may include a heating element configured to heat the liquid contained in the first container 101 and/or to maintain a user-selected temperature. This heating element 113 may be configured by a user manually (e.g., using a switch or panel on the device) or remote-controlled via a cellular phone, computer or other electronic device. In some implementations, the heating element 113 may be configured to activate and/or adjust the temperature according to a user-defined schedule or profile.

In some aspects, the coffee brewing device may be configured to store and/or use one or more profiles. Profiles may be user-specific or specific to a given type of beverage or a brewing protocol. Profiles may be created on the device and stored in non-volatile memory and/or transferred to the device from a user's cellular phone, computer or other electronic device. For example, the device may include a profile for a first user that sets forth a brewing protocol which uses a particular grinding speed for the grinder 103 and/or which sets the heating element 113 to a particular temperature. The device may include a profile for a second user having alternative parameters.

Devices according to this aspect and all of the other beverage brewing devices disclosed herein may be used to brew coffee or other beverages based on beans or any other edible material which may be ground and steeped in a liquid to produce a beverage suitable for human consumption. For simplicity, the beverage brewing methods described herein refer to the use of coffee beans. However, it is understood that in other aspects according to the disclosure alternative materials (e.g., tea leaves and other plant-derived materials) may be ground by the devices disclosed herein and steeped in liquid to produce beverages suitable for human consumption. In some aspects, a beverage may comprise two or more different materials, such as a mixture of coffee beans and an additional edible material to be infused into the coffee during the brewing process (e.g., a fruit, a spice, cocoa, or any other edible material selected to provide flavor, nutritional value, or any other desired trait).

Devices according to the aspect of FIG. 1A may be operated by adding coffee beans to the second container 102, closing the second container (e.g., by attaching the filter 104), and attaching the second container 102 (now containing coffee beans) to the bottom end of the first container 101. As indicated above, the motor 106 configured to drive the grinder 103 may be included as part of the first container 101 or located within a separate base 105. FIG. 1A illustrates the latter configuration. As a result, a user would proceed to attach the first container 101 to the base 105 to provide power to the grinder 103. Once assembled, coffee may be brewed by adding sufficient liquid to the first container 101 to fully or partially submerge the coffee beans located in the second container 102, and activating the grinder 103 (e.g., using a switch 112) positioned on the first container 101 or the base 105.

At this stage, various components of the coffee beans will then be extracted by the liquid (e.g., by dissolving into the liquid or forming an emulsion), passing through the filter 104 and gradually converting the liquid placed in the first container 101 into a coffee beverage. In some aspects, the ground coffee may be steeped for 1-10 minutes, 5-15 minutes, or 10-20 minutes or any integer range within the span of 1-20 minutes. However, it is understood that longer period of steeping may be useful when preparing a coffee beverage and may be necessary or preferred when preparing a beverage based on other edible materials. In some cases, brewing may take place over a span of between 0.5 to 10 minutes at 0-10° C. (e.g., to produce a cold brew coffee beverage) or 0.5 to 10 minutes at 80-100° C. (e.g., to produce a hot coffee beverage). Brewing may proceed using any temperature and time parameters selected by a user to produce a given beverage. Exemplary parameters include a brewing temperature between 0-100° C. and a brewing time of 0.5-60 minutes. However, these ranges are expressly non-limiting. In some cases, higher temperatures and longer brewing times may be preferred.

FIGS. 1B, 1C, 1D and 1E include respective examples of second containers 102 compatible with the coffee brewing device of FIG. 1A and various other implementations disclosed herein. In these example implementations, a second container 102 may comprise one or more filters 104 across any surface of the second container 102. In some implementations, the lateral wall(s) of the second container 102 include one or more filter 104 regions (e.g., FIG. 1B). In some implementations, the entire upper and lateral surface of the second container 102 may comprise a filter 104. (e.g., FIG. 1C). Alternatively, discrete filter 104 regions may be placed at multiple points along the lateral and/or upper surface of the second container 102 (e.g., FIG. 1D). Filter 104 regions may also be placed on the surface which is configured to attach to the first container 101 (e.g., FIG. 1E).

One or more of the filter 104 regions on the second container 102 may be detachable (e.g., allowing a user to open the second container 102 in order to insert coffee beans or other edible material(s) to be ground within the second container 102). In some implementations, the detachable filter 104 is attached by a hinge, faster, locking mechanism or any other means of securing the filter 104 to the second container 102. The second container 102 may alternatively be configured to allow a user to open the second container 102 along a surface that does not contain a filter 104. For example, a second container 102 according to the implementation depicted in FIG. 1A (with a filter 104 along the upper surface) may be structured as two halves (e.g., a first half comprising the filter 104 and a portion of the side wall(s) and a second half comprising the bottom surface, grinder 103 and a portion of the side wall(s)). These halves may be threaded along the interface between the halves allowing a user to join or separate the halves by rotating the two halves in opposite directions along this interface. In other implementations, the second container 102 may include a surface (e.g., a filter 104 region, or a solid region) which can be manipulated by a user to open the second container, such as a solid surface that detaches from the second container 102 or rotates along a hinge to allow access to the inside of the second container 102.

The second container 102 may generally be structured as any enclosed volume adapted to fit within a larger brewing container (e.g., the first container of FIG. 1A), having a means for grinding coffee beans or other edible material(s) contained within the volume and at least one interface allowing contact between a liquid placed in the brewing container and the contents of the enclosed volume. In some aspects, the second container 102 is a pod, chamber, compartment, capsule, case or other vessel.

In some aspects, the first container 101 may be substantially larger than the second container 102, e.g., to hold large volumes of liquid. For example, the first container may be sized to hold 1-10 L, 10-100 L, 100-1000 L or >1000 L. The contents of the first container 101 may be water used to make commercial volumes of a beverage that will later be dried or freeze-dried (e.g., to make instant coffee), served to consumers, or bottled for future sale. In some aspects, the liquid in the first container may be water or another beverage (e.g., beer) and the second container 102 may contain one or more edible additives, nutritional or dietary supplements, flavoring agents or enhancers, or other compounds to be ground and infused into the beverage contained in the first container 101.

FIG. 2 includes a coffee brewing device 200 according to another aspect of the disclosure. Beverage brewing devices according to this aspect of the disclosure may include a first container 201, having a top end and a bottom end, wherein a least a portion of the bottom end comprises a filter 202; a base 203 adapted to attach to the bottom end of the first container 201, comprising a motor 204; and a second container 205 comprising a top end, a bottom end, and a grinder 206 positioned within the second container 205 and configured to be operated by the motor 207; wherein the bottom end of the second container 205 is adapted to attach to the base 203 at a position.

The aspect of the coffee brewing device of FIG. 2 is similar to the aspect of the coffee brewing device of FIG. 1. In FIG. 2, however, the configuration of the second container 205 is adapted to attach to a base 203 rather than attaching to the inside of the first container 201 as in FIG. 1. This configuration of FIG. 2 may be preferable to some users, as it avoids the need for a user to place their hand into the first container 201 to attach the second container 205 (e.g., as is the case when operating a device according to the aspect shown in FIG. 1). The aspect of FIG. 2 is also distinguishable in that it includes a filter component (e.g., filter 202) on the first container 201 instead of on the second container 205, in contrast to the aspect of FIG. 1.

Notwithstanding these structural differences, it is understood that devices according to this aspect may feature any or all of the optional elements, features and configurations described above in the context of FIG. 1 or elsewhere in this disclosure. For example, such devices may include a switch 208 configured to activate the grinder 206, the motor 207 configured to operate the grinder 206 and/or a power supply 209. The power supply 209 may comprise a battery 210 included in the base 203, and the grinder 206 may be a burr grinder or a rotary grinder. In addition, in FIG. 1, the base 203 may also be attachable to a second base 209, which includes any or all of the components of the device (e.g., the motor 207, the power supply 209, an optional heating element 210). Similarly, the second container 205 may feature any aspect(s) of the second container of FIGS. 1A-D described above.

A user may operate a brewing device according to FIG. 2 by adding coffee beans to the second container 205 and then attaching it to the base 203. The first container 201 is then attached to the base 203. In some aspects, the first container 201 and/or the base 203 may be adapted to fit together to form a waterproof seal (e.g., to prevent liquid from escaping the first container 201 during the brewing process). This may be achieved, in some aspects, by including a gasket along the rim of either or both of the first container 201 and/or the base 203 surfaces which come into contact with each other when assembled. This interface may also include an optional locking mechanism adapted to prevent separation of the two components during use. For example, in some aspects the interface between the first container 201 and/or the base 203 may include a locking mechanism (e.g., the two sections may be threaded to form a tight fit when one section is rotated). In any event, after securing the first container 201 to the base 203, a user may add liquid to the first container 201. In some aspects, the volume of liquid will be sufficient to partially or totally submerge the coffee beans located in the second container 205. The base 203 may then be connected to a power supply 209 (e.g., located in the base 203 or in a second base as shown in FIG. 2) and the grinder 206 may be activated to grind the coffee beans, resulting in the production of coffee beverage in the first container 201. The parameters for the coffee brewing process (e.g., steeping time) may follow any protocol described herein in the context of FIG. 1 or be selected by a user as necessary for a given implementation.

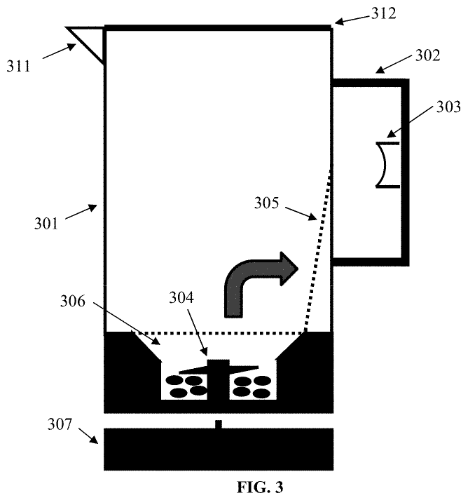

FIG. 3 includes an example of a coffee brewing device 300 according to another aspect of the disclosure. Beverage brewing devices according to this aspect of the disclosure may include a container 301, having an top end and a bottom end; a handle 302 attached to an outside surface of the container and comprising a switch 303; a grinder 304, attached to an inside surface of the container 301 at the bottom end; a repositionable filter 305 attached to an inside surface of the container 301, configured to move into an open position or a closed position in response to operation of the switch 303; wherein the closed position places the repositionable filter 305 between the top end and the bottom end of the container 301, defining a compartment 306 at the bottom end containing the grinder 304; and a base 307 adapted to attach to the bottom end of the container 301, comprising a motor 308 configured to operate the grinder 304.

In some aspects, the device includes a means for locking the repositionable filter 305 in a closed position, wherein the locking means is configured to unlock in response to operation of the switch 303. The repositionable filter 305 may be attached to the inside of the container by a fastener or hinge which allows movement of the repositionable filter 305. The switch 303 may positioned on the handle 302 of the device as shown in FIG. 3 or alternately to any other surface of the device. In some aspects, the device may be configured to be communicate with a user's mobile or electronic device allowing remote control and activating of the device (e.g., allowing control of the switch 303 or the grinder 304). As described above in the context of other aspects, the base 307 may include a power supply 309, and/or an optional heating element 310. Similarity, the grinder 304 may be any type or configuration described herein or otherwise suitable to grind coffee beans or other edible materials used to brew a beverage using the device. To be clear, devices according to this aspect may feature any or all of the optional elements, features and configurations described above in the context of FIG. 1 or elsewhere in this disclosure.

A user may operate a brewing device according to FIG. 3 by unlocking the repositionable filter 305 and moving it to the open position (e.g., using the switch 303) and placing coffee beans in the compartment 306 at the bottom end of the container 301. The repositionable filter 305 may then be placed in the closed position and optionally locked in place if a fastening mechanism is implemented. The user may then add water to the container 301 to fully or partially submerge the coffee beans, and then activate the grinder 304. As described above in the context of other aspects, extractable compounds within the ground coffee beans will dissolve and/or form an emulsion in the liquid and pass through the repositionable filter 305 to form a coffee beverage in the container 301.

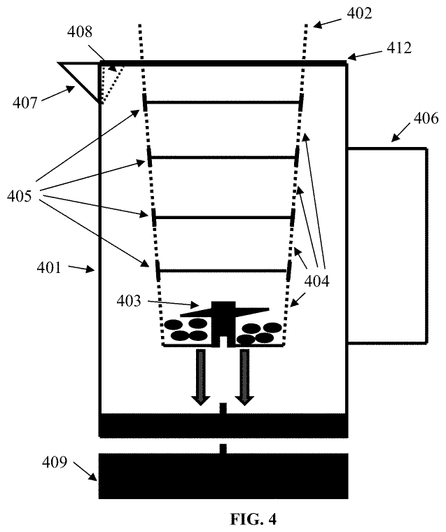

FIG. 4 includes an example of a coffee brewing device 400 according to another aspect of the disclosure. This aspect of the coffee brewing device may be similar to the configuration in FIG. 1, but with a filter cap 405 placed within the second container 402. FIG. 4 also includes the use of a spout filter 408 to filter out any remaining grinds and particles suspended in the coffee beverage. In some aspects, this spout filter 408 may be a multi-layer filter (e.g., a tri-filter having a course, fine and super-fine mesh) Filter caps 405 and/or a spout filter 408 may be incorporated into any brewing device disclosed herein.

As noted above, the second container 402 shown in this figure demonstrates the use of a filter cap 405 component. To be precise, the cross section view of FIG. 4 illustrates four separate filter caps 405 placed at different heights within the second container 402. During normal operation, only one such filter cap 405 would typically be used. For example, for a 2-cup batch a user may select a filter cap 405 that is sized to fit at the second position, counting upward from the bottom of the second container 402, whereas a 4-cup batch may be prepared with the filter cap 405 sized to fit at the top-most position, providing additional space for the grinding and a higher volume of liquid. The filter cap 405 is then placed on or fastened to the second container to create a compartment in which the grinding may take place. The filter cap 405 may be attached to the second container 402 by any fastening means described herein or otherwise known in the art and may optionally include a locking mechanism to secure the filter cap 405 in place.

Devices according to this aspect may feature any or all of the optional elements, features and configurations described above in the context of FIG. 1 or elsewhere in this disclosure. Similarly, coffee (and other beverages) may be prepared using devices according to this aspect according to any protocol and using any parameters described herein.

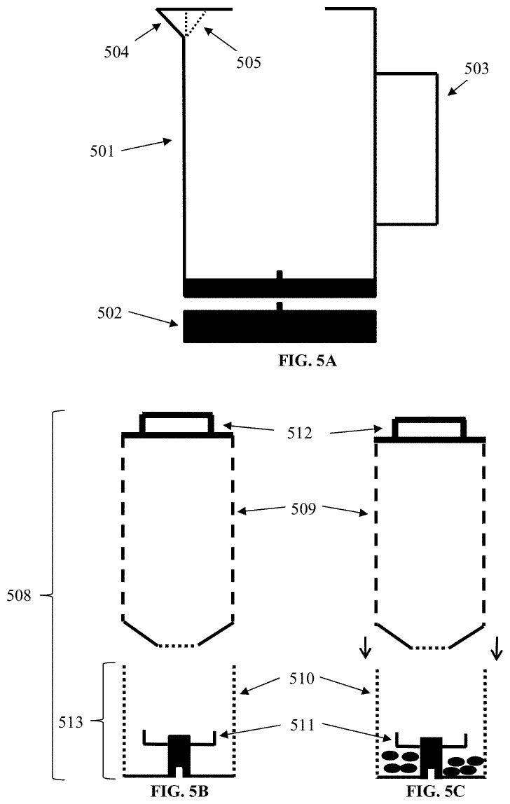

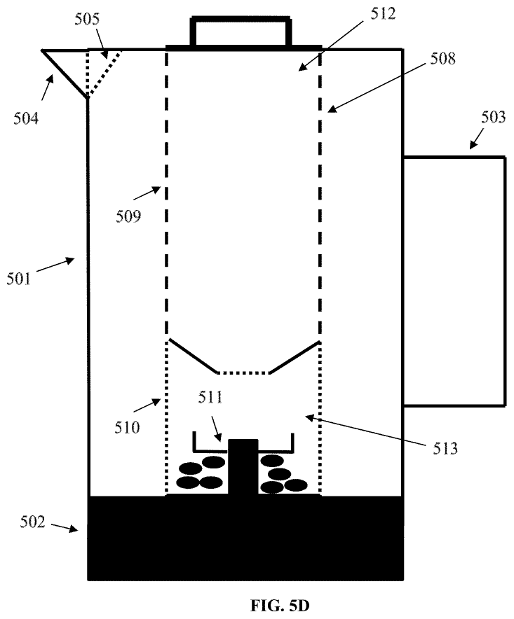

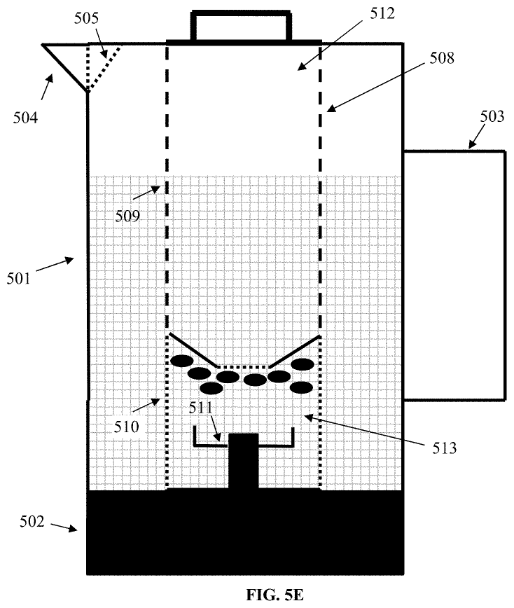

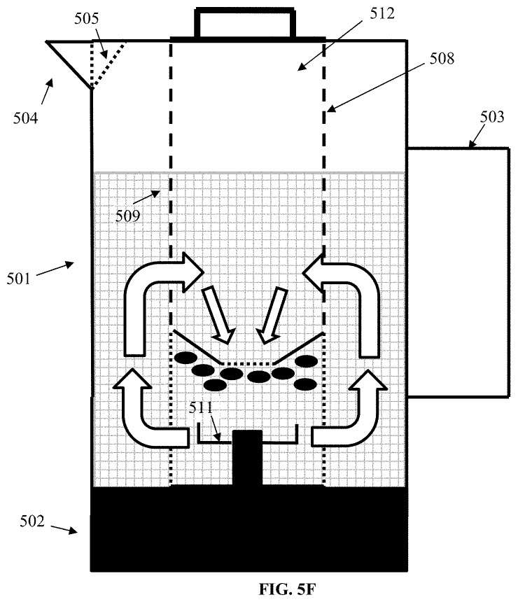

FIG. 5A includes an example of a coffee brewing device 500 according to another aspect of the disclosure, in a disassembled state. In particular, FIG. 5A depicts a container 501, having a top end and a bottom end, and a base 502 adapted to attach to the bottom end of the container 501, comprising a motor configured to operate a grinder 511.

FIG. 5B includes an example of a grinding assembly 508 configured to fit within the container 501, comprising: an upper portion (a lid 512 attached to a scaffold 509), and a detachable lower compartment 513 having a bottom end and one or more sidewalls, wherein at least a portion of the sidewall(s) comprises a filter 510. A grinder 511 is attached to the lower compartment 513 at the bottom end.

The scaffold 509 may comprise one or more discrete components. In some implementations, the scaffold 509 comprises a lid 512 attached to one or more substantially vertical extensions which extend downward from the lid into the container 501, which may be configured to contact the lower compartment 513. In some aspects, the lid 512 is detachable from the scaffold 509. The scaffold 509 may be shaped to form a sealed compartment within the container 501 or structured as a cage (e.g., comprising one or more pores or filter 510 portions) which allow liquid in the container 501 to pass through the scaffold 509. The scaffold 509 may also be adapted to form a compartment that isolates coffee beans loaded in the device in some aspects. In some implementations, the scaffold 509 comprises a heating element configured to heat or maintain the temperature of liquid stored in the container 501 (e.g., an inductive heating component or a resistive heating component). The lower compartment 513 may include one or more filter 510 regions along the side wall(s) of this compartment. In some aspects, the lower compartment 513 is defined by a filter 510 on all sides.

FIG. 5C includes an example of the grinding assembly 508 of FIG. 5B loaded with coffee beans. Arrows illustrate the joining of an upper portion of the grinding assembly 508 (e.g., the lid 512 and scaffold 509) with the lower compartment 513. This upper portion of the grinding assembly 508 may rest against the lower compartment 513 (e.g., held in place by gravity) or be securely fastened to the lower compartment 513 (e.g., by a clasp, a threaded interface or a locking mechanism).

FIG. 5D includes an example of the grinding assembly 508 of FIG. 5B inserted into the coffee brewing device of FIG. 5A, illustrating a fully assembled configuration of an exemplary coffee brewing device loaded with coffee beans. A user may operate a brewing device according to FIG. 5A-D by placing coffee beans in the lower compartment 513 of a grinding assembly 508 and attaching the scaffold 509 and lid 512 portion to the lower compartment 513 to fully assemble the grinding assembly 508. The user may then add a volume of liquid (e.g., water) to a container 501 sufficient to fully submerge the lower compartment 513 when the grinding assembly 508 is fully inserted into the container 501 in its operable configuration. After adding this liquid, the user may then insert the now assembled grinding assembly 508 into the container and attach the lower compartment 513 of the grinding assembly 508 to the bottom end of the container 501, allowing the motor in the container 501 (or in the base 502 in some implementations) to drive the grinder 511 positioned within the lower compartment 513. At this point, the user may activate the grinder 511, grinding the coffee beans loaded into the lower compartment 513 and generating a coffee beverage in the container 501 as components within the ground coffee beans are extracted and pass through the one or more filter 510 regions of the side wall(s) defining the lower compartment 513.

In some aspects, the user may assemble the brewing device by attaching the lower compartment 513 to the bottom end of the container 501 and then attaching the upper portion of the grinding assembly 508 to the lower compartment 513. However, in typical implementations users may find it preferable to fully assemble the grinding assembly 508 before inserting this subassembly into the container 501.

FIGS. 5D and 5E include examples of a fully assembled configuration of the coffee brewing device shown in FIG. 5C, loaded with coffee beans and liquid and ready to initiate the grinding process. As shown by FIG. 5D, coffee beans will typically float within the lower compartment 513, and be held in place by a vertical segment of the scaffold 509 or a side wall of the lower compartment 513 (e.g., forming a cage or pod suitable for preventing coffee beans from floating upwards and exiting the lower compartment 513). FIG. 5F is an annotated view of this configuration showing an exemplary fluid path created by operation of the grinder 511. In this example, fluid travels laterally away from the grinder 511 through the filter 510 sections of the lower compartment 513, upwards through the container 501, through the scaffold 509 and then back into the lower compartment 513 via a filter section positioned along the lower surface of the scaffold 509, completing a fluid circuit. This fluid path may be generated by selecting a grinder 511 configuration (e.g., a position and angle of a pair of rotary grinder blades) suitable to direct water away from the grinder 511 along a lateral direction.

Devices according to this aspect may feature any or all of the optional elements, features and configurations described above in the context of FIG. 1 or elsewhere in this disclosure. Similarly, coffee (and other beverages) may be prepared using devices according to this aspect according to any protocol and using any parameters described herein.

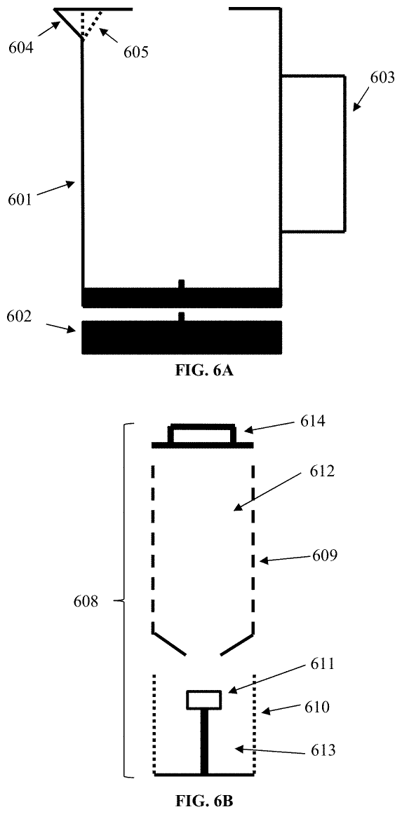

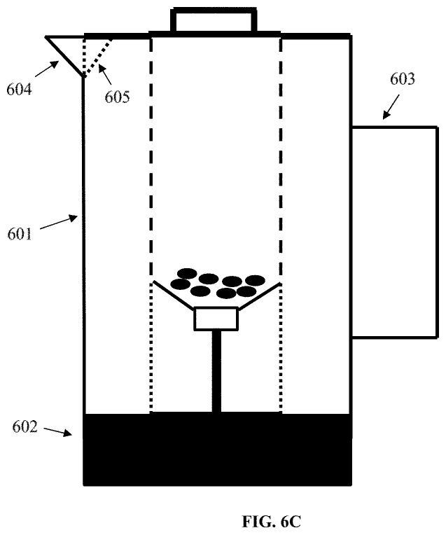

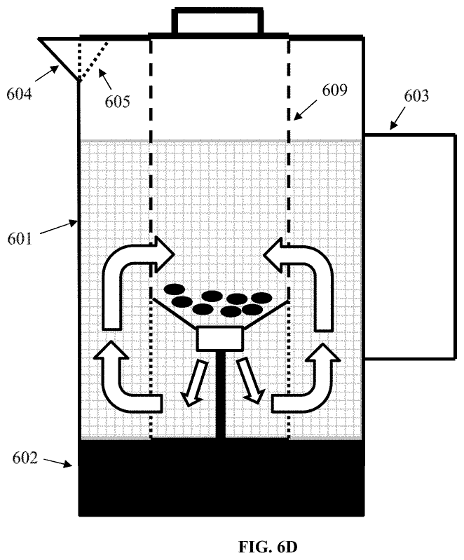

FIG. 6A includes an example of a cross-sectional view of a coffee brewing device 600 according to another aspect of the disclosure, in a disassembled state. In particular, FIG. 6A depicts a container 601, having a top end and a bottom end, and a base 602 adapted to attach to the bottom end of the container 601, comprising a motor configured to operate a grinder 611.

FIG. 6B includes example of a grinding assembly 608 configured to fit within the container 601, comprising: an upper portion (a lid 614 attached to a scaffold 609), and a detachable lower compartment 613 having a bottom end and one or more sidewalls, wherein at least a portion of the sidewall(s) comprises a filter 610. A grinder 611 is attached to the lower compartment 613 at the bottom end. In this example, the grinder is a pumping burr grinder. In some aspects, such as the configuration illustrated by this figure, the burr grinder is turned by action of a shaft that connects to the bottom of lower compartment 613 and is actuated by the motor located within the container 601 or base 602.

The scaffold 609 may comprise one or more discrete components. In some implementations, the scaffold 609 comprises a lid 614 attached to one or more substantially vertical extensions which extend downward from the lid into the container 601, which may be configured to contact the lower compartment 613. In some aspects, the lid 612 is detachable from the scaffold 609. The scaffold 609 may be shaped to form a sealed compartment within the container 601 or structured as a cage (e.g., comprising one or more pores or filter 610 portions) which allow liquid in the container 601 to pass through the scaffold 609. The scaffold 609 may also be adapted to form a compartment that isolates coffee beans loaded in the device in some aspects. In some implementations, the scaffold 609 comprises a heating element configured to heat or maintain the temperature of liquid stored in the container 601 (e.g., an inductive heating component). The lower compartment 613 may include one or more filter 610 regions along the side wall(s) of this compartment. In some aspects, the lower compartment 613 is defined by a filter 610 on all sides.

FIG. 6C includes an example of the grinding assembly 608 of FIG. 6B inserted into the coffee brewing device of FIG. 6A, illustrating a fully assembled configuration of the coffee brewing device loaded with coffee beans. Notably, in this case coffee beans are loaded into the container 601 and/or in a compartment formed by the scaffold 609, as opposed to loaded into the lower compartment 613. FIG. 6D is an annotated view of this configuration showing an exemplary fluid path created by operation of the grinder 611.

A user may operate a brewing device according to FIG. 6A-D by attaching the scaffold 609 to the lower compartment 613 to assemble the grinding assembly 608. The user may then insert the now assembled grinding assembly 608 into the container and attach the lower compartment 613 of the grinding assembly 608 to the bottom end of the container 601, allowing the motor in the container 601 (or in the base 602 in some implementations) to drive the grinder 611 positioned within the lower compartment 613. The detachable lid 614 may then be removed from the scaffold 609 so that the user may then add a volume of liquid (e.g., water) to a container 601 sufficient to fully submerge the lower compartment 613 and at least a portion of the scaffold 609 when the grinding assembly 608 is fully inserted into the container 601 in its operable configuration. After adding this liquid, the user may then load coffee beans into the device through the opening along the upper surface of the container 601 (i.e., the opening created by removing the lid 612). Coffee beans may settle along the top of the lower compartment 613 as shown in FIG. 6C or settle elsewhere in the container 601. At this point, the user may activate the grinder 611, which in this example is a pumping burr grinder, grinding the coffee beans loaded into the compartment 601. Coffee grinds are trapped by the filter 610 lining the lower compartment 613. A coffee beverage is generated in the container 601 as components with the ground coffee beans are extracted and pass through the one or more filter 610 regions of the side wall(s) defining the lower compartment 613. As illustrated by FIG. 6D, the grinder 611 may be configured to produce a fluid path that circulates from the grinder 611 through the filter 610 regions to the container 601, scaffold 609 and then completing the circuit back to the grinder 611.

Devices according to this aspect may feature any or all of the optional elements, features and configurations described above in the context of FIG. 1 or elsewhere in this disclosure. Similarly, coffee (and other beverages) may be prepare using devices according to this aspect according to any protocol and using any parameters described herein.

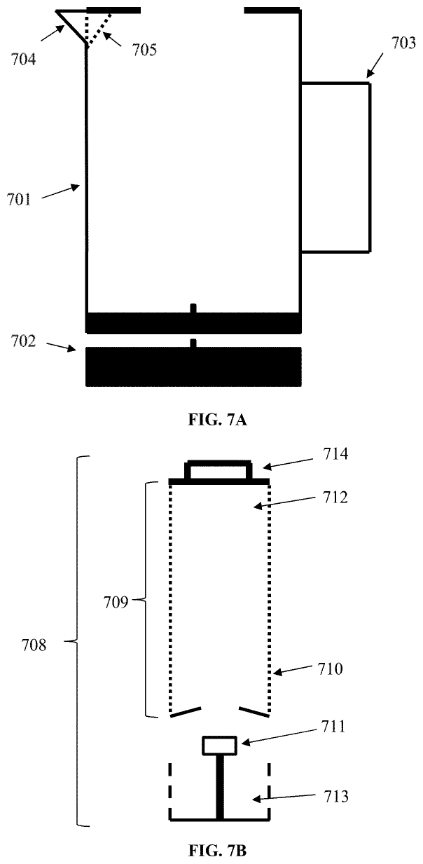

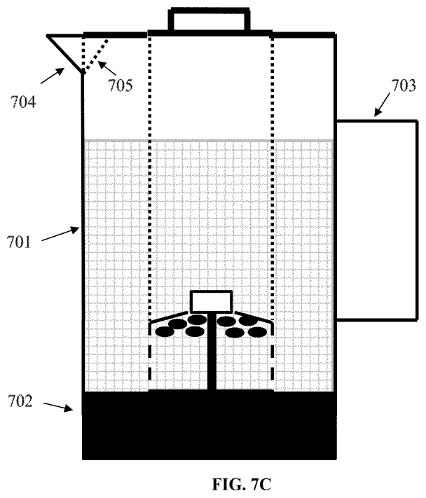

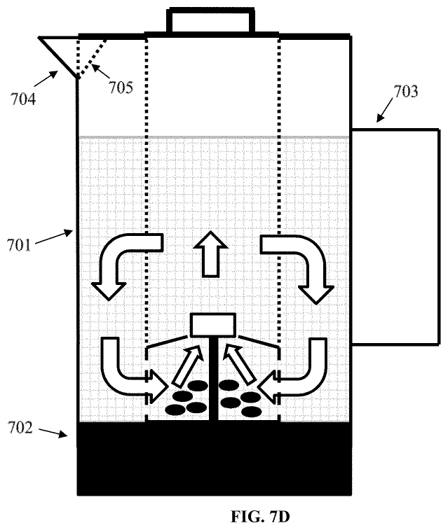

FIGS. 7A and 7B include examples of a coffee brewing device 700 and grinding assembly 708 according to another aspect of the disclosure. The exemplary implementation shown by these figures is substantially similar to the implementation of FIGS. 6A-D. However, in this configuration coffee beans are loaded into the lower compartment 713 and the direction of the fluid path is reversed (e.g., as shown by FIG. 7D). Furthermore, as illustrated by this implementation the upper section 709 of the grinding assembly 708 may comprise a filter while the bottom section 713 comprises a scaffolding structure forming a cage to contain coffee beans. A device according to this aspect may be assembled by loading coffee beans into the lower compartment 713 prior to attaching the scaffold 709 and lid 714 portion of the grinding assembly 708. Liquid may then be added to the container 701 and the complete grinding assembly 708 may then be inserted into the device. Coffee beans are ground by the pumping burr grinder and grinds are then collected by the filter 710 regions of the scaffold as the coffee beverage is generated. Thus, in this configuration the scaffold 709 may be formed as a distinct compartment bordered by side walls and at least one filter 710 region in order to effectively trap coffee grinds.

Devices according to this aspect may feature any or all of the optional elements, features and configurations described above in the context of FIG. 1 or 6, or elsewhere in this disclosure. Similarly, coffee (and other beverages) may be prepare using devices according to this aspect according to any protocol and using any parameters described herein.

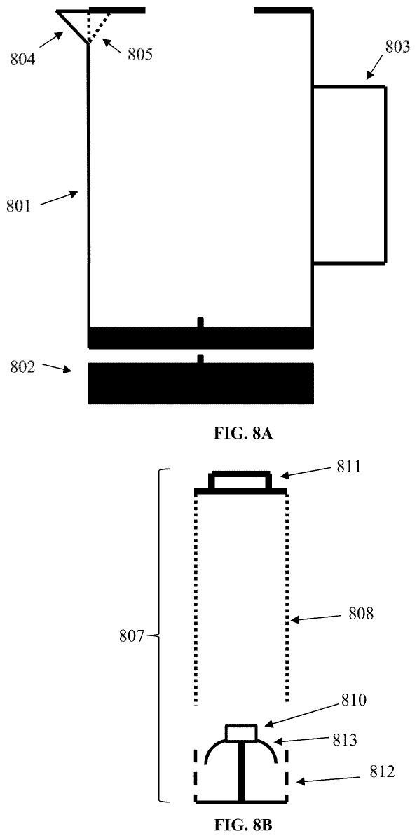

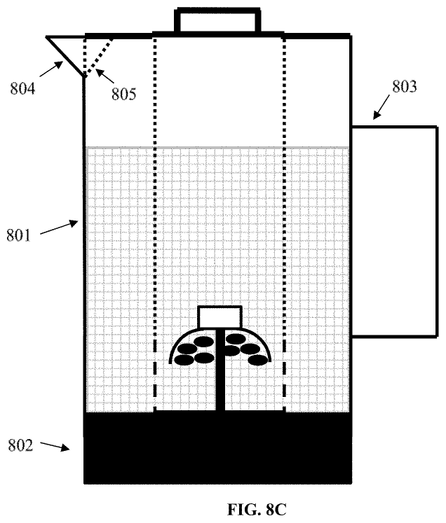

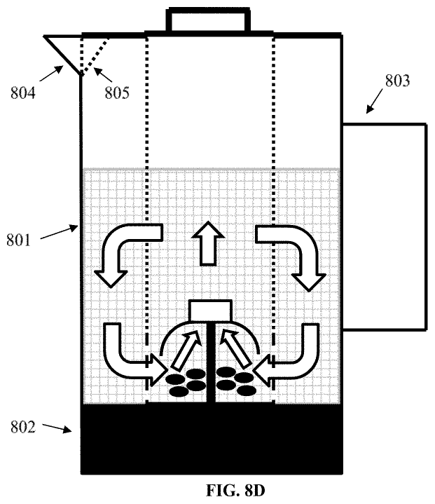

FIGS. 8A and 8B include examples of a coffee brewing device 800 and grinding assembly 807 according to another aspect of the disclosure. FIGS. 8C and 8D depict this implementation loaded with water and annotated to show an exemplary fluid path during grinding. The exemplary implementation shown by these figures is substantially similar to the implementation of FIGS. 7A-D. However, the lower compartment 812 further includes a cup or funnel-shaped structure designed to collect and/or direct coffee beans loaded in the lower compartment 812 towards the grinder 810, which in this example is a pumping burr grinder. The cup may be detachable or may contain a spring-loaded trap door to allow for the loading of coffee beans into the lower compartment 812. In some implementations, the trap door may be made of buoyant material which allows it to float upwards and close when submerged. In some implementations, the cup 813 will typically have a gap between it and the walls of the lower compartment 812 which is narrower than the standard diameter of a coffee bean, allowing the compartment 812 to effectively trap coffee beans. Smaller particulates can pass through this gap once they are processed through the grinder 810, and be reprocessed by the grinder to enable a very consistent final grind size.

Devices according to this aspect may feature any or all of the optional elements, features and configurations described above in the context of FIG. 1, 6 or 7, or elsewhere in this disclosure. Similarly, coffee (and other beverages) may be prepare using devices according to this aspect according to any protocol and using any parameters described herein.

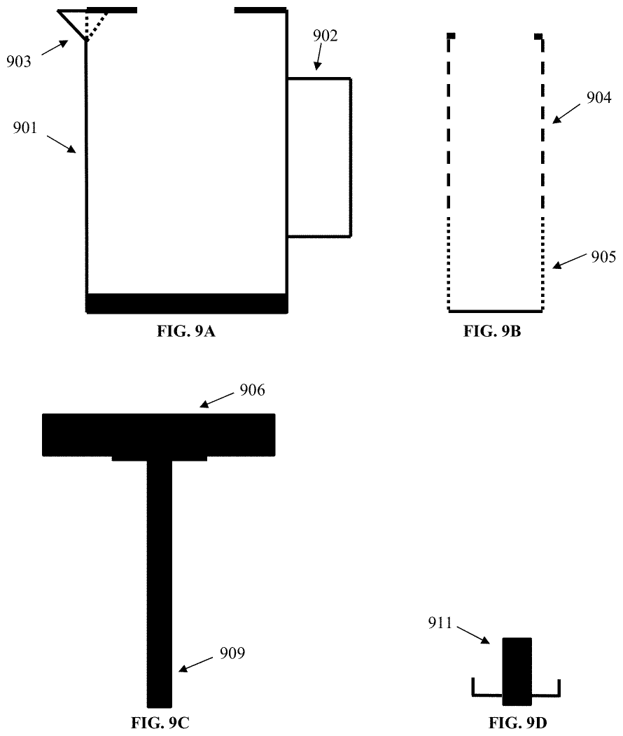

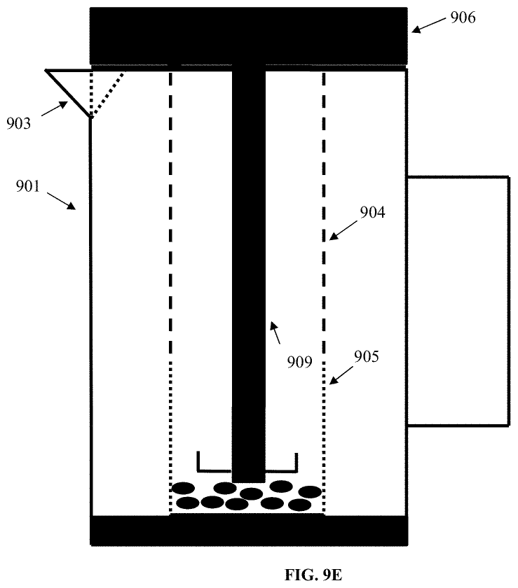

FIG. 9A includes examples of a coffee brewing device 900 according to another aspect of the disclosure, in a disassembled state. This implementation differs from the preceding exemplary implementations in that the grinder 911 is attached to a grinder mount 909 which extends into the container 901 from the upper end of the container 901. FIGS. 9B-D depict cross section views of additional subassemblies that may be combined with the device of FIG. 9A to produce a fully assembled and operable configuration. In particular, FIG. 9B depicts a scaffold 904 having at least one filter 905 section, FIG. 9C depicts a lid 906 and grinder mount 909, and FIG. 9D depicts a detachable grinder 911 which may be attached to the grinder mount 909.

FIG. 9E includes an example of a coffee brewing device 900 produced by combining the subassemblies of FIGS. 9A-D, loaded with coffee beans. As illustrated by this figure, a user may operate a device according to this general implementation by adding coffee beans the compartment formed by the scaffold 904 (which acts as a cage to prevent coffee beans from escaping) and filter 905 (e.g., as shown by FIG. 9B). Prior to or after this step, a user may attach a grinder 911 to the grinder mount 909. In some implementations, the grinder mount 909 is located at the distal end of a vertical protrusion or shaft extending downward from the lid 906 into the container 901 when the lid 906 is placed on the container 901 in an operable configuration. The scaffold 904 and filter 905 subassembly may then be attached to the combined lid 906 and grinder mount 909 subassembly (e.g., as shown by FIG. 9C). The scaffold 904 and/or filter 905 may be configured to attach to lid 906 using a fastener, locking mechanism, threading or any other means for attaching the scaffold 904 to the lid 906. Coffee is brewed using this fully assembled device by adding a sufficient volume of liquid to the container 901 to cover or partially cover the detachable grinder (e.g., by adding liquid to container 901 prior to adding the lid 906 and grinder mount 909 subassembly to the device) and activating the grinder in order to generate a coffee beverage in the container 901.

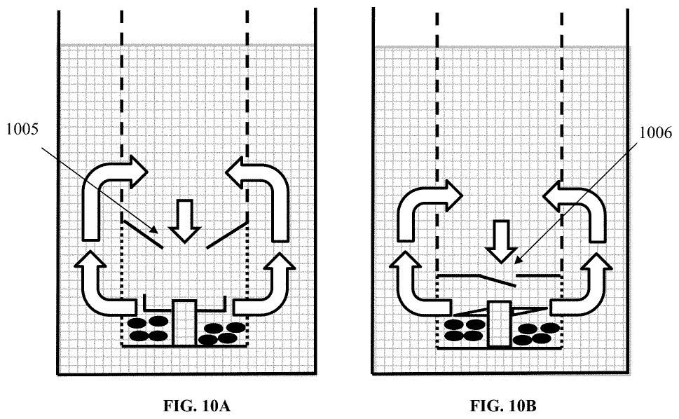

FIGS. 10A and B include examples of alternative grinding assemblies that may be adapted for use with any of the brewing devices disclosed herein (e.g., the device of FIGS. 4-8). As illustrated by FIGS. 10A and 10B, guides and/or valves may be used to direct the fluid path of liquid within the container during the grinding process.

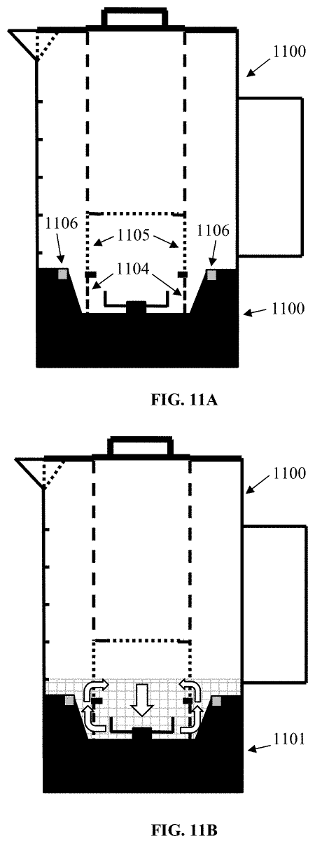

FIGS. 11A and B include examples of a coffee brewing device according to another aspect of the disclosure. FIG. 11A includes an implementation in an assembled but unfilled state. FIG. 11B includes the same implementation partially filled with water. In FIG. 11B, devices according to the disclosure may be used to brew coffee or another beverage when the container is less than fully filled. In this implementation, the bottom end 1101 of the container 1100 can be shaped to form a shallow bowl or recess 1102, collecting liquid and enabling a smaller volume of liquid, (e.g., an amount roughly the amount suitable for one cup of coffee), to cover the blades 1103 and providing sufficient volume for circulation filtering and proper grinding of the coffee beans (or other edible materials). This implementation also includes a heating element 1106 integrated into the bottom end of the container adjacent to the grinding assembly. Furthermore, as illustrated by this implementation, filter(s) incorporated into a grinding pod may contain two or more different filter densities. In this implementation, the lower portion of pod with sidewalls 1104 adjacent to the blades 1103, contain a coarse filter while the upper portion 1105 contains a fine filter. Optionally, the lower portion 1104 may contain a fine filter while the upper portion 1105 contains a coarse filter. The interplay between coarse and fine filters may serve to better implement circulating filtration. It is understood that any combination or arrangement of filter densities may be selected for the top, bottom and sidewall(s) of a pod, or any portions thereof. Accordingly, other aspects may include alternative combinations of filters, as may be suitable to filter any given edible material selected for grinding. In some aspects, a pod may have a plurality of filters incorporated into one or more surfaces, with each filter (or a portion thereof) having an independently selected filter density. In some aspects, one or more filters incorporated into a pod may have a density that changes according to a gradient (e.g., a pod may have a fine filter section along the top, bottom, or side wall(s) which gradually shifts to a coarse filter section, either on the same or an adjacent surface of the pod). In some aspects, one or more filters incorporated into a pod may have a pore size of 10 μm to 1,000 μm or any size within this range (e.g., 10 μm, 25 μm, 50 μm, 100 μm, 250 μm or 500 μm). In some aspects one or more filters incorporated into a pod may have a pore size ranging from: 10-50 μm, 10-100 μm, 10-250 μm, 10-500 μm, 20-60 μm, 30-70 μm, 40-80 μm, 50-90 μm, 60-100 μm, 100-200 μm, 200-300 μm, 300-400 μm, 400-500 μm, 500-600 μm, 600-700 μm, 700-800 μm, 800-900 μm, 900-1,000 μm, or a range bounded by a combination of any two endpoints selected from the preceding ranges.

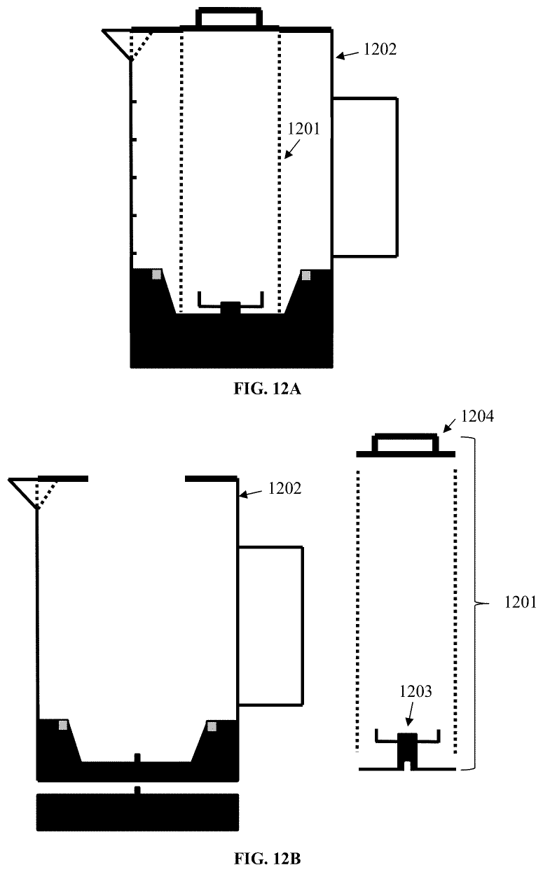

FIGS. 12A and B include examples of a coffee brewing device 1200 according to another aspect of the disclosure, in an assembled state (FIG. 12A) and disassembled state (FIG. 12B). This implementation differs from the preceding example implementations in that the grinding pod assembly 1201 comprises a full-length cylindrical mesh compartment which extends from the top end to the bottom end of the container 1202. In the disassembled view (FIG. 12B), both the grinder 1203 and the lid 1204 may be detachable, allowing for easy loading of the grinding pod assembly 1201 and cleaning of the grinder assembly 1203 components.

FIG. 14A includes an example of a pod 1400 attached to a scaffold 1401 according to an aspect of the disclosure. As discussed above in the context of various other implementations, the scaffold 1401 may attach to the pod 1400 and/or to the lid to provide efficient assembly and handling of a beverage brewing device. As illustrated by this figure, the scaffold 1401 may comprise a heating element 1402 such as an inductive heating component. FIG. 14B includes various alternative configurations of a scaffold which may be used with this or any other implementation described herein.

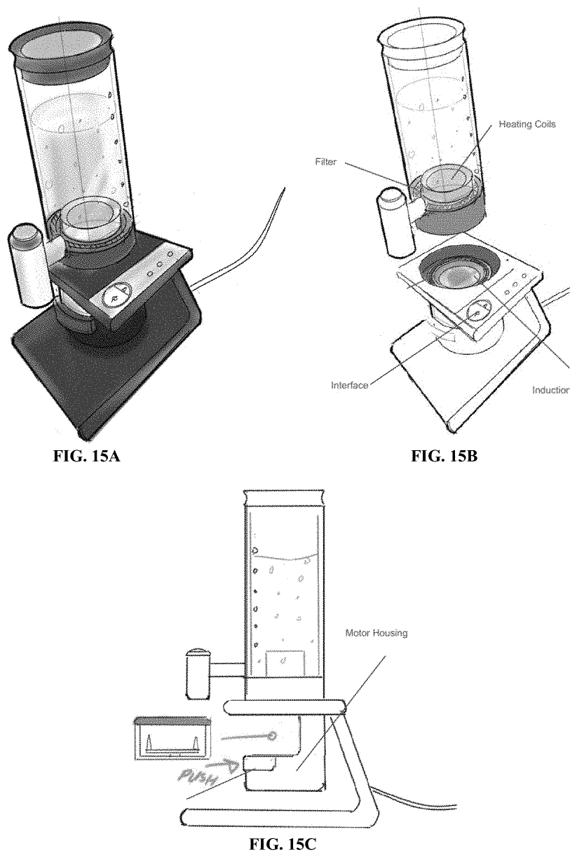

FIGS. 15A and B includes an example of a beverage brewing device 1500 according to another aspect of the disclosure in an assembled (FIG. 15A) and disassembled (FIG. 15B) state. In this particular example, the water reservoir is a container which includes a tap for dispensing beverages and a heating element. The container is attachable to a base that includes the inductor element used to activate the heating element and a control interface for operating the brewing device (e.g., for controlling the grinder and brewing parameters). FIG. 15C depicts a side view of this same beverage brewing device. As illustrated by this figure, pods may be laterally inserted into a slot or receptacle in the base of this device. This alternative slot loading configuration may be used as part of any of the brewing devices disclosed herein.

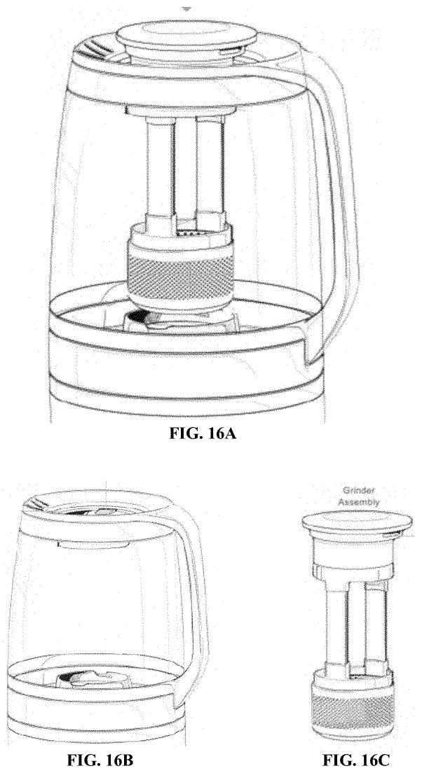

FIGS. 16A-C includes an example of a beverage brewing device 1600 according to another aspect of the disclosure in an assembled (FIG. 16A) and disassembled (FIGS. 16B and 1C) state. In devices according to this general implementation, the water reservoir is structured as a kettle or other container which receives the grinding assembly. As depicted by FIG. 16C, the grinding assembly may comprise a scaffold and lid attached (or attachable) to a grinding pod. Aspects of this general implementation may be incorporated into any of the alternative brewing device configurations described herein.

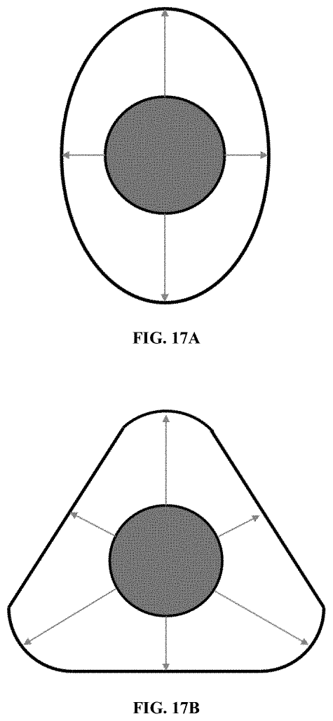

FIGS. 17A and B depict top views of two alternative container configurations that may be used with any of the beverage brewing devices disclosed herein. In particular, FIG. 17A illustrates an oval outer container and FIG. 17B illustrates a triangular outer container. The fluid dynamics of liquid circulating through the beverage brewing device are dictated in part by the shape of the outer container. Irregularly-shaped containers may improve the efficiency of the grinding and/or mixing process, and in some aspects may be selected for aesthetic reasons.

### Brewing Methods

Various beverages, and in particular coffee beverages, may be brewed using the devices and methods described herein. In some aspects, a beverage may be brewed by providing one or more edible organic material(s), and optionally one or more edible inorganic materials (e.g., salts); placing at least a portion of the edible material(s) in any of the pods described herein; submerging the pod in a liquid, wherein the liquid is sufficient to fully or partially submerge the edible material(s); grinding the edible material(s); and generating a beverage. In some aspects, the beverage may be generated by further steeping the ground-up edible material(s) in the liquid. Any material suitable for human consumption may be used to brew a beverage according to this general procedure. The steeping time and temperature, grinding speed and grinder configuration parameters may be varied by a user based upon the edible material being used to brew the beverage (some material may require additional or reduced steeping time, a particular grinding speed, etc.). It is envisioned that parameters will be selected by a user depending on the application. As described above, devices according to the disclosure may allow a user to create, save and/or execute customization options and routines (e.g., user or beverage profiles). In some aspects, devices according to the disclosure may execute particular brewing protocols for different beverages using such profiles.

An exemplary protocol for brewing a coffee beverage according to the disclosure may include placing an amount of coffee beans in any of the pods described herein; placing the pod within a container; adding hot or cold water to the container; submerging or partially submerging the grinding pod in the hot or cold water in the container; generating coffee grinds by grinding the coffee beans using the grinder in the pod, wherein the grinding is subject to one or more selected parameters; optionally further steeping the coffee grinds in the hot or cold water; and obtaining the coffee beverage from the container. Variable parameters include the grinding speed, steeping temperature, and steeping time. In some aspects, grinding may initially proceed at high speed for a short time followed by a “mixing” process at a slower speed for a longer duration to enhance flavor and obtain a fuller extraction (e.g., 7000 rpm for 60 seconds followed by 700 rpm for 180 seconds).

Coffee brewed using the devices and methods described herein may advantageously be prepared in a short period of time (e.g., <5 minutes) while possessing many of the properties associated with cold brew coffee which normally requires ˜14 hours of steeping. In some aspects, coffee may be brewed by steeping for less than 5, 10 or 20 minutes at any temperature between 0 and 100° C.

### Coffee Beverage Compositions

Coffee compositions described herein may contain one or more compounds which are normally not extracted by conventional brewing methods and/or unique concentrations of compounds found in conventionally brewed coffee beverages. For example, coffee compositions according to the present disclosure may contain enriched levels of total fats, polyunsaturated fats, antioxidants and other compounds of interest. In some implementations, such coffee beverages may include one or more of the following: at least 0.25% total fat, at least 0.1% saturated fat, at least 0.1% polyunsaturated fat, and/or at least 0.1% trans-fat. In some aspects, the coffee composition may have at least 0.10%, 0.15%, 0.20%, 0.30%, 0.35%, 0.40%, 0.45% or 0.50% total fat, or a total fat concentration within the range of 0.10%-0.50%, 0.20%-0.40%, 0.25%-0.35%, or any combination of minimum and maximum values therein. In some aspects, the coffee composition may have at least 0.05%, 0.15%, 0.20%, 0.25%, 0.30%, 0.35%, 0.40%, 0.45% or 0.50% saturated fat, or a saturated fat concentration within the range of 0.05%-0.50%, 0.1%-0.40%, 0.15%-0.35%, or any combination of minimum and maximum values therein. In some aspects, the coffee composition may have at least 0.05%, 0.15%, 0.20%, 0.25%, 0.30%, 0.35%, 0.40%, 0.45% or 0.50% polyunsaturated fat, or a polyunsaturated fat concentration within the range of 0.05%-0.50%, 0.1%-0.40%, 0.15%-0.35%, or any combination of minimum and maximum values therein.

Coffee compositions disclosed herein may have a polyphenol concentration of ≥100 mg/100 ml , ≥125 mg/100 ml, ≥150 mg/100 ml, 50-250 mg/100 ml, 100-200 mg/100 ml, 125-175 mg/100 ml, or any integer value within these ranges.

Coffee compositions may also have a particulate concentration of ≤5 mg/mL, ≤6 mg/mL, ≤7 mg/mL, or a particulate concentration within the range of 5-7 mg/mL, 4-8 mg/mL, 3-9 mg/mL, 2-10 mg/mL, 1-11 mg/mL or any or any combination of minimum and maximum integer values within these ranges.

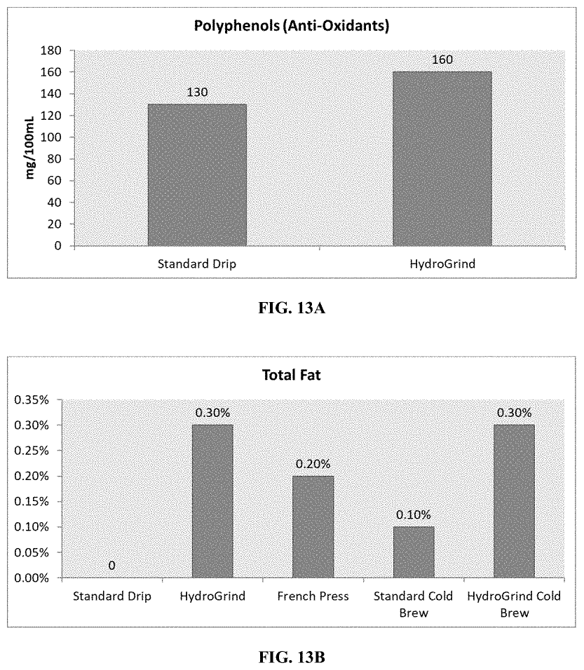

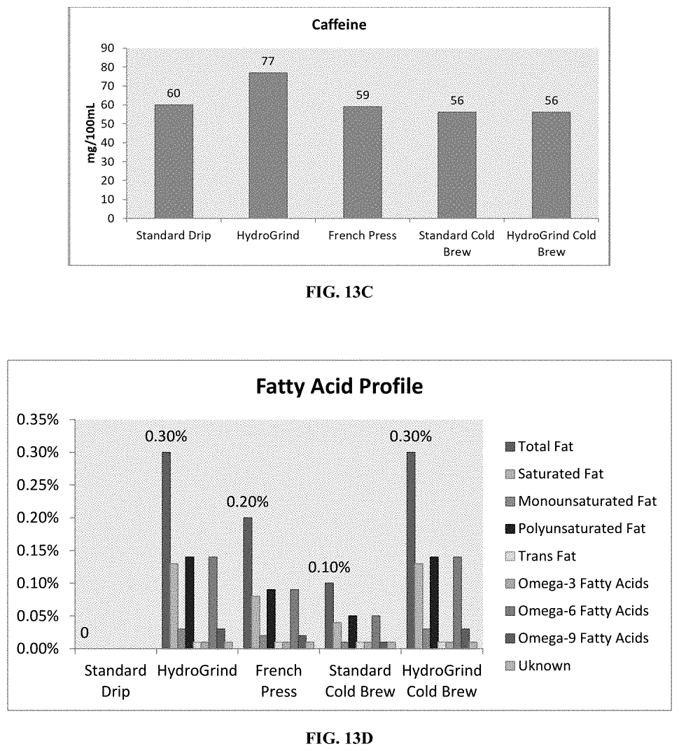

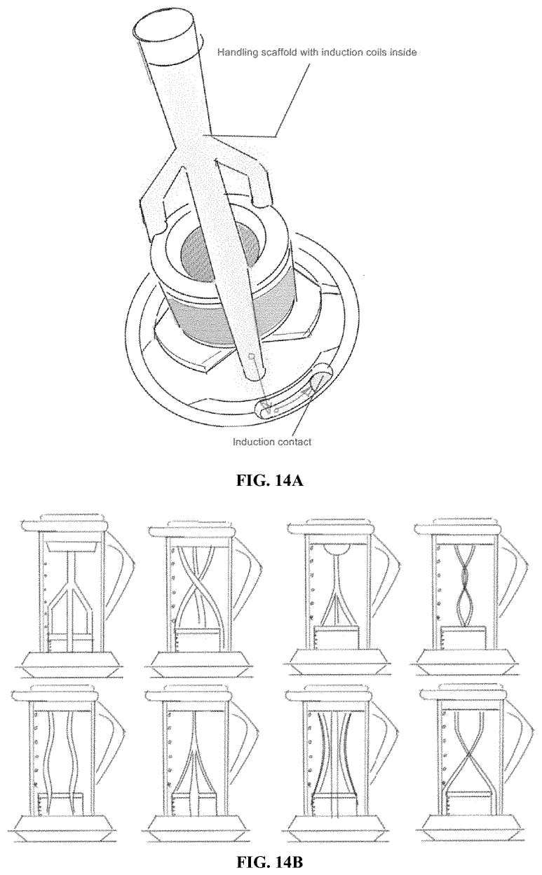

As discussed above, coffee brewing methods and devices provided herein are capable of generating coffee having a unique extraction profile compared to coffee produced via conventional brewing methods. For example, coffee produced by the present methods may have a higher concentration of total fat, fatty acids and antioxidants compared to conventional drip-based and French press brewing methods and without the long steeping time requirements of cold brew methods. A subset of these differences are illustrated by FIGS. 13A-D, which summarize the results of comparative studies using coffee brewed using an exemplary device and method according to the present disclosure against known brewing protocols.

These particular comparative studies analyzed coffee compositions generated by brewing “medium roasted” coffee beans ground and brewed in water at a 6% w/v ratio of coffee beans to water. However, it is understood that the amounts or concentrations of assayed compounds will typically vary in a linear fashion as this w/v ratio is adjusted upward or downward from 6% (e.g., a 3% w/v ratio of coffee beans to water is expected to result in approximately half of the amount or concentration of a given analyte being present in the resulting coffee beverage). In view of this linear relationship, anticipated levels can be readily calculated for various coffee beverages across a wide range of ratios, e.g., 1-20% w/v ratios and for subranges contained therein.

It is also understood that the concentration or amount of extracted compounds will vary depending on the degree of roasting of the coffee beans used to produce a coffee beverage. Higher temperatures and/or prolonged roasting changes the chemical composition of coffee beans. For example, the level of caffeine in “blond roast” coffee beans will typically be higher than the level of caffeine in coffee beans obtained from the same source which have been subjected to “medium roast” or “dark roast” processing because a larger portion of the caffeine will undergo chemical decomposition during the extended roasting process. However, expected concentrations and amounts of extracted compounds obtained from coffee beans subjected to “blond roast,” “dark roast” or other such levels of roasting may be extrapolated from the data provided by FIGS. 13A-D by simply accounting for the higher or lower starting amounts and presuming the same linear relationship across different w/v ratios.

Consequently, it is understood that all of the amounts, concentrations and ranges of these values disclosed herein may be adjusted to account for alternative w/v ratios and the roasting level of coffee beans used to produce a given coffee beverage. Adjustment of these value may include accounting for an alternative starting amount of a given compound in the coffee beans or grounds used to brew the beverage and projecting that the resulting beverages will display the same linear relationship with regard to the concentration of amount of the compound across various w/v ratios.

FIG. 13A is a bar graph illustrating differences in the polyphenol (antioxidant) content of coffee brewed using an exemplary device according to the present disclosure compared to coffee brewed using a conventional drip-based brewing device. Data was collected for this assay in accordance with the Folin-Ciocalteu method described in Methods of Enzymology, Vol. 299, Oxidants and Antioxidants Part A, Pages 152-178, 1999. As illustrated by this graph, the present methods are capable of extracting more polyphenol compounds (e.g., antioxidants) from ground coffee, surpassing the 130 mg/mL resulting from a conventional drip-based method, which assumes a 6% coffee solids to water ratio.

FIG. 13B is a bar graph illustrating differences in the total fat content of coffee brewed using an exemplary device according to the present disclosure compared to coffee brewed using several conventional brewing devices and methods. As illustrated by this graph, the present methods are capable of extracting approximately 1.5× more total fat from ground coffee than French press coffee methods (i.e., 0.30% total fat, which assumes 6% coffee solids to water ratio). It is further notable that the amount of total fat extracted is surprisingly unaffected by the brewing temperature. In contrast, a standard coffee brewing method assayed provided poor extraction of total fat and a standard drip-based protocol produced zero extraction. Without being limited to a theory, the increased total fat content extracted using the present methods may explain the improved flavor profile and unique color associated with coffee produced using the present methods. This substantial difference in total fat content further suggests that the present methods may extract lipid compounds that are normally not extractable using conventional methods, resulting in a unique composition that cannot be replicated using conventional techniques.

FIG. 13C is a bar graph illustrating differences in the caffeine content of coffee brewed using an exemplary device according to the present disclosure compared to coffee brewed using several conventional brewing devices and methods. Data was collected for this assay by HPLC in accordance with Official Method of Analysis of AOAC Intentional protocol AOAC 980.14. As illustrated by this graph, coffee produced using the current methods extracts more caffeine than conventional methods when brewed with a hot steeping step (77 mg/100 ml). A cold brewing protocol using the present method and a traditional cold brewing method both resulted in coffee with lower caffeine content (56 mg/100 ml), demonstrating that the present methods are capable of producing a beverage comparable to cold brew, with respect to caffeine content, in substantially less time (e.g., 5 minutes versus ˜14 hours).

FIG. 13D is a bar graph illustrating differences in the fatty acid profile of coffee brewed using an exemplary device according to the present disclosure compared to coffee brewed using several conventional brewing devices and methods. Data was collected for this assay by gas chromatography in accordance with Official Method of Analysis of AOAC Intentional protocols AOAC 969.33 and AOAC 996.06. As illustrated by this graph, the present methods produce coffee having substantially enriched fatty acid content compared to conventional methods. For example, standard and cold brewing protocols using exemplary methods of the present disclosure produced coffee with an omega-6 and omega-3 fatty acid concentration that noticeably exceeds standard cold brew, French press techniques. As noted above in the analysis of total fat content, standard drip-based methods fail to extract any measurable level of fatty acids.

### Other Beverage Compositions

Devices and methods according to the present disclosure may be used to brew coffee as described in detail above. However, it is understood that the present devices and methods may also be used to brew any other beverage suitable for human consumption and may also be used to mix a beverage with additional components (e.g., additional flavoring agents or flavor enhancers, dietary supplements, and other beneficial compounds). For example, a coffee beverage may be brewed according to any of the methods described herein, with an additional flavoring agent or nutritional supplement added to the pod prior to grinding such as fruit, chocolate, one or more spices or extracts, and any other compound(s) or edible material(s) that can be ground by the grinder provided in the pod in order to produce a coffee beverage infused with the additional edible materials. Alternatively, the present methods may be used to brew or enhance non-coffee beverages such as tea, juice or beer. Such beverages may be generated by infusing ground up edible materials into water or by infusing these materials into a pre-existing beverage to enhance its flavor, nutritional value, or to provide other beneficial properties. In some aspects, the resulting or enhanced beverage may be subsequently freeze dried or otherwise preserved to allow later consumption or for commercial distribution.

1. A pod adapted for use with a beverage brewing device, comprising:
an upper wall;
a lower wall;
one or more side walls connecting the upper wall and the lower wall to form a compartment; and
a grinder attached to an inner surface of the compartment and adapted to grind an edible material;
wherein at least a portion of the upper wall, the lower wall, and/or the one or more side walls comprises a filter adapted to allow fluid communication through the pod.

2. The pod of claim 1, wherein the grinder comprises a rotary grinder.

3. The pod of claim 1, wherein the grinder is a burr grinder.

4. The pod of any one of claims 1-3, wherein the grinder comprises a burr grinder or a rotary grinder adapted to grind coffee beans.

5. The pod of any one of claims 1-4, wherein the pod is configured to allow detachment of the filter from the container.

6. The pod of any one of claims 1-5, wherein the filter is attached to the container by at least one hinge or clasp.

7. The pod of any one of claims 1-6, wherein an outer surface of the pod is shaped to attach to a surface of a container and the container comprises one or more of the following:
a fluid reservoir;
a motor configured to drive the grinder;
a switch configured to activate the grinder; and/or
a power source configured to power the grinder.

8. The pod of any one of claims 1-7, wherein an outer surface of the pod is shaped to attach to a surface of a container, the container comprises a fluid reservoir and is attached to a base, and the base comprises one or more of the following:
a motor configured to drive the grinder;
a switch configured to activate the grinder; and/or
a power source configured to power the grinder.

9. The pod of any one of claims 1-8, wherein the filter comprises:
a mesh filter;
a solid support having one or more pores; and/or
a porous material configured to allow fluid communication across the material while retaining edible material grinds.

10. The pod of any one of claims 1-9, wherein the pod further comprises:
a cap adapted to attach to the pod, the cap defining an upper wall of the pod.

11. The pod of any one of claims 1-10, wherein the pod comprises one or more of the following:
a pumping burr grinder;
one or more interchangeable blades;
one or more blades adapted to provide simultaneous grinding and mixing;
a grinding element having at least one flat blade and at least one bent blade; and/or
a grinding element having at least one flat blade, wherein the flat blade is substantially vertical or horizontal.

12. The pod of any one of claims 1-11, wherein the grinder comprises a “U”-shaped blade shaped to provide force to direct liquid laterally through at least one filter of the pod.

13. The pod of any one of claims 1-12, wherein the grinder is configured to perform filtration by repeatedly circulating liquid through at least one filter of the pod.

14. A beverage brewing device, comprising:
the pod of any one of claims 1-13;
a container, having a top end and a bottom end;
wherein the pod is configured to attach to an inner surface of the bottom end of the container, and optionally, the top end; and
a base adapted to attach to the bottom end of the container, comprising a motor configured to operate the grinder.

15. A beverage brewing device, comprising:
the pod of any one of claims 1-13;
a first base, adapted to allow the pod to attach to an upper surface of the first base;
a second base, adapted to allow the first base to attach to an upper surface of the second base, wherein the second base comprises a power supply configured to power the grinder and a motor configured to operate the grinder; and
a container, having a top end and a bottom end, wherein at least a portion of the bottom end comprises a filter adapted to allow fluid communication between the container and the pod;
wherein the pod is configured to attach to an inner surface of the bottom end of the container.

16. A beverage brewing device, comprising:
the pod of any one of claims 1-13;
a container, having a top end and a bottom end;
wherein the container is configured to allow attachment of the pod to an inner surface of the top end and an inner surface of the bottom end of the container; and
a base adapted to attach to the bottom end of the container, comprising a motor configured to operate the grinder.

17. A beverage brewing device, comprising:
the pod of any one of claims 1-13;
a container, having a top end and a bottom end;
wherein the container is configured to allow attachment of the pod to an inner surface of the bottom end of the container;
a base adapted to attach to the bottom end of the container, comprising a motor configured to operate the grinder; and
a scaffold extending along a vertical axis of the container, adapted to attach to the pod.

18. The beverage brewing device any one of claims 14-17, wherein the base and/or the container comprises at least one of the following:
a heating element adapted to heat or maintain the temperature of a liquid stored in the container;
a switch configured to activate the grinder; or
a power supply configured to power the grinder.

19. The beverage brewing device of any one of claims 14-17, further comprising a second container which comprises a fluid reservoir, where the device is configured to enable or block fluid communication between the container and the fluid reservoir of the second container in response to user input.

20. The beverage brewing device of claim 17, wherein the scaffold comprises a heating element adapted to heat or maintain the temperature of a liquid stored in the container

21. The beverage brewing device of claim 17, wherein the scaffold is further adapted to attach to a lid of the device.

22. The beverage brewing device of claim 21, wherein the lid is detachable.

23. A method of brewing a beverage, comprising:
placing an edible material in the pod of any one of claims 1-13;
submerging the pod in a liquid, wherein the liquid is sufficient to fully or partially submerge the edible material;
grinding the edible material; and
generating a beverage by steeping the ground-up edible material in the liquid.

24. The method of claim 23, wherein the edible material comprises a plurality of coffee beans.

25. The method of claim 24, wherein the ground-up coffee is steeped for less than 5, 10, or 20 minutes.

26. The method of claim 24, wherein the ground-up coffee is steeped at a temperature of 0-25° C.

27. A method of brewing a coffee beverage, comprising:
placing an amount of coffee beans in the pod of any one of claims 1-13;
placing the pod within a container;
adding hot or cold water to the container;
at least partially submerging the pod in the hot or cold water in the container; and
generating coffee grinds by grinding the coffee beans using the grinder in the pod, wherein the grinding is subject to one or more selected parameters; and
optionally, further steeping the coffee grinds in the hot or cold water.

28. The method of claim 27, wherein the amount of coffee beans placed in the pod is any one of the following: 20 g, 5-20 g, 10-30 g, 15-40 g, 20-50 g or >50 g.

29. The method of claim 27 or 28, further comprising:
attaching the pod to a scaffold prior to placing the pod in the container, wherein the scaffold is attached to an upper surface or a lower surface of the pod, and/or
a pod that attaches both to the bottom and top of the container.

30. The method of claim 27, wherein a volume of the hot or cold water added to the container is: 100-200 mL, 201-300 mL, 301-400 mL, 401-500 mL or >500 mL.

31. The method of claim 27, wherein the one or more selected parameters include:
a motor rotation speed parameter;
a grinder run time parameter;
a temperature parameter and/or
a post-grinding steeping time parameter.

32. The method of claim 27, wherein steeping the coffee grinds in the hot or cold water comprises steeping for any one of the following durations of time: <5 minutes, 5-10 minutes, 10-20 minutes, 20-30 minutes or >30 minutes.

33. The method of claim 27, wherein adding the hot or cold water to the container comprises adding the hot or cold water having a temperature of: 0-5° C., 5-10° C., 10-20° C., 20-30° C., 30-50° C., 50-80° C. or 80-100° C.

34. A coffee composition comprising coffee beans ground and brewed in water with an approximately 6% w/v ratio of coffee beans or grounds to water, comprising one or more of the following:
at least 0.25% total fat;
at least 0.1% saturated fat; and/or
at least 0.1% polyunsaturated fat.

35. A coffee composition comprising coffee beans ground and brewed in water at a 6% w/v ratio of coffee beans or grounds to water, comprising at least 140 mg/100 ml polyphenol content.

36. A coffee composition comprising coffee beans ground and brewed in water at a 6% w/v ratio of coffee beans or grounds to water, comprising at least 65 mg/100 ml caffeine content.

37. A coffee composition comprising coffee beans ground and brewed in water at a 6% w/v ratio of coffee beans or grounds to water, comprising a substantially brown color.

38. A coffee composition, generated by coffee grounds that have been exposed to oxygen only at levels of <1%.

39. A coffee composition comprising coffee beans ground and brewed in water with an approximately 6% w/v ratio of coffee beans or grounds to water, having any or all of the physical properties, amounts or concentrations required by claims 34-37, wherein the coffee composition has a particulate concentration of ≤10 mg/mL.

40. The coffee composition of any one of claims 34-38 wherein the ratio of coffee beans or grounds to water are at a ratio other than 6% but the relationship of the ratio to the physical property, amount or concentrations remains linear.

41. The coffee composition of any one of claims 34-38, wherein the coffee is brewed in water at a temperature of 0 to 25° C.

42. The coffee composition of any one of claims 34-38, wherein the coffee is brewed within 15 minutes.

43. The coffee composition of any one of claims 34-38, wherein the coffee is brewed within 15 minutes in water at a temperature of 0 to 25° C.

44. A beverage brewing device, comprising:
a first container, having a top end and a bottom end;
a second container adapted to attach to the bottom end of the first container, comprising a grinder and a filter;
wherein the grinder is positioned within the second container; and
a base adapted to attach to the bottom end of the first container, comprising a motor configured to operate the grinder.

45. The beverage brewing device of claim 44, wherein the grinder is a burr grinder or a rotary grinder.

46. The beverage brewing device of any one of claim 44 or 45, wherein the filter is a mesh filter comprising a metallic sieve having one or more openings adapted to allow a liquid to pass through the filter.

47. The beverage brewing device of any one of claims 44-46, wherein the filter is a mesh filter attached to the second container by at least one hinge or clasp.

48. The beverage brewing device of any one of claims 44-47, wherein the grinder is a rotary grinder adapted to grind coffee beans.

49. The beverage brewing device of any one of claims 44-48, wherein the grinder comprises one or more blades.

50. The beverage brewing device of any one of claims 44-49, wherein the grinder comprises a “U”-shaped blade adapted to provide force to laterally direct liquid through at least one filter of the pod.

51. The beverage brewing device of any one of claims 44-50, wherein the device comprises a grinder configured to perform filtration by repeatedly circulating liquid through at least one filter of the pod.

52. The beverage brewing device of any one of claims 44-51, wherein the second container is a pod or canister.

53. The beverage brewing device of any one of claims 44-52, wherein the first container is non-circular and adapted such that water emanating from a second container will have variable path lengths to the walls of the first container.

54. A beverage brewing device, comprising:
a first container, having a top end and a bottom end;
wherein a least a portion of the bottom end comprises a filter;
a base adapted to attach to the bottom end of the first container, comprising a motor; and
a second container comprising a top end, a bottom end, and a grinder positioned within the second container and configured to be operated by the motor;
wherein the bottom end of the second container is adapted to attach to the base at a position.

55. The beverage brewing device of claim 54, wherein the base (a) further comprises a power supply connected to the motor; or (b) is connectable to an external power supply capable of powering the motor.

56. The beverage brewing device of any one of claim 54 or 55, wherein the grinder is a burr grinder or a rotary grinder.

57. The beverage brewing device of any one of claims 54-56, wherein the filter is a mesh filter comprising a metallic sieve having one or more openings adapted to allow a liquid to pass through the filter.

58. The beverage brewing device of any one of claims 54-57, wherein the grinder is a rotary grinder adapted to grind coffee beans.

59. A beverage brewing device, comprising:
a container, having a top end and a bottom end;
a handle attached to an outside surface of the container and comprising a switch;
a grinder, attached to an inside surface of the container at the bottom end;
a repositionable filter attached to an inside surface of the container, configured to move into an open position or a closed position in response to operation of the switch;
wherein the closed position prevents fluid communication between the container and the compartment; and
a base adapted to attach to the bottom end of the container, comprising a motor configured to operate the grinder.

60. The beverage brewing device of claim 59, further comprising a means for locking the filter in a closed position, wherein the locking means is configured to unlock in response to operation of the switch.

61. The beverage brewing device of claim 59 or 60, wherein the repositionable filter is a mesh filter attached to the inside surface of the container by at least one hinge.

62. The beverage brewing device of any one of claims 59-61, wherein the base (a) further comprises a power supply connected to the motor; or (b) is connectable to an external power supply capable of powering the motor.

63. The beverage brewing device of any one of claims 59-62, wherein the grinder is a burr grinder or a rotary grinder.

64. The beverage brewing device of any one of claims 59-63, wherein the repositionable filter comprises a metallic sieve having one or more openings adapted to allow a liquid to pass through the filter.

65. The beverage brewing device of any one of claims 59-64, wherein the grinder is a rotary grinder adapted to grind coffee beans.

66. A beverage brewing device, comprising:
a first container, having a top end and a bottom end;
a second container, having a top end, a bottom end, and a side wall;
wherein at least a portion of the side wall, the bottom end, and/or the top end comprises a filter;
a grinder, attached to the second container at the bottom end;
a partition positioned within the second container, which defines an upper chamber and a lower chamber, wherein the lower chamber contains the grinder; and
a base adapted to attach to the bottom end of the second container, comprising a motor configured to operate the grinder.

67. The beverage brewing device of claim 66, wherein the filter comprises a majority of the surface area of the second container.

68. The beverage brewing device of claim 66 or 67, wherein the partition is adapted to prevent suction of air into the grinder during operation of the grinder.

69. The beverage brewing device of any one of claims 66-68, wherein the filter is structured as a cylinder or a conical cylinder.

70. The beverage brewing device of any one of claims 66-69, wherein the second container further comprises at least one attachment point configured to fasten or secure the filter in place

71. The beverage brewing device of any one of claims 66-70, wherein the base (a) further comprises a power supply connected to the motor; or (b) is connectable to an external power supply capable of powering the motor.

72. The beverage brewing device of any one of claims 66-71, wherein the grinder is a burr grinder or a rotary grinder.

73. The beverage brewing device of any one of claims 66-72, wherein the filter comprises a metallic sieve having one or more openings adapted to allow a liquid to pass through the filter.

74. The beverage brewing device of any one of claims 66-73, wherein the grinder is a rotary grinder adapted to grind coffee beans.

75. A beverage brewing device, comprising:
a container, having a top end and a bottom end;
a grinder assembly configured to fit within the container, comprising:
an upper compartment having a top end, a bottom end, and a side wall, wherein at least a portion of the bottom end of the upper compartment comprises a filter, grating or valve and the sidewalls allow water to flow through into the container;
a detachable lower compartment having a bottom end and a side wall, wherein at least a portion of the side wall and/or the bottom end comprises a filter;
a grinder, attached to the lower compartment at the bottom end; and
a base adapted to attach to the bottom end of the container, comprising a motor configured to operate the grinder.

76. The beverage brewing device of any one of claims 44-75, further comprising a heating element integrated into the device.

77. The beverage brewing device of claim 76, wherein:
the heating element is integrated into a base, compartment or container of the device; and/or
the heating element is configured to heat or maintain the temperature of a liquid stored in a container or compartment of the device.

78. The beverage brewing device of any one of claims 44-77, wherein the grinder comprises one or more of the following:
a pumping burr grinder;
one or more interchangeable blades;
one or more blades adapted to provide simultaneous grinding and mixing;
a grinding element having at least one flat blade and at least one bent blade; and/or
a grinding element having at least one flat blade, wherein the flat blade is substantially vertical or horizontal.

79. The beverage brewing device of any one of claims 44-78, wherein the grinder comprises a “U”-shaped blade.

80. The beverage brewing device of any one of claims 44-78, wherein the grinder comprises a “U”-shaped blade adapted to provide force to laterally direct liquid through at least one filter of the pod.

81. The beverage brewing device of any one of claims 44-80, wherein the device comprises a grinder configured to perform filtration by repeatedly circulating liquid through at least one filter of the pod.

82. A grinder assembly adapted to fit within a beverage brewing device, comprising:
a container adapted to store one or more edible materials; and
a grinder;
wherein the grinder is attached to an inside surface of the container.

83. The grinder assembly of claim 82, wherein the container comprises:
a sealed bottom end, a side wall attached to the bottom end, and an open end; and
the grinder is attached to the inner surface of the sealed bottom end of the container.

84. The grinder assembly of claim 82 or 83, wherein the edible material comprises one or more coffee beans.

85. A method of brewing coffee, comprising:
providing a coffee brewing device comprising
a first container, having a top end and a bottom end;
a second container adapted to attach to the bottom end of the first container, comprising a grinder and a filter;
wherein the grinder is positioned within the second container; and
a base adapted to attach to the bottom end of the first container, comprising a motor configured to operate the grinder;
placing a plurality of coffee beans within the second container;
adding liquid to the first container sufficient to fully or partially submerge the coffee beans in the second container; and
generating coffee by grinding the submerged coffee beans and allowing soluble and/or extractable components of the coffee beans to dissolve or form an emulsion in the liquid.

86. The method of claim 85, wherein the liquid added to the container is at least:
0° C. to 100° C.;
0° C. to 20° C.; or
80° C. to 100° C.;
when added to the container.

87. The method of claim 85 or 86, wherein the extractable components of the coffee beans are allowed to dissolve and/or form an emulsion in the liquid over a period of at least:
0.5 to 10 minutes;
10 to 30 minutes; or
30 to 90 minutes.

88. A method of brewing coffee comprising
at least partially submerging coffee beans in container comprising water, wherein there is an approximately 6% w/v ratio of coffee beans to water; and
grinding the coffee beans to obtain coffee,
wherein the coffee comprises at least 0.25% total fat, at least 0.1% saturated fat, at least 0.1% polyunsaturated fat, at least 140 mg/100 ml polyphenol content, at least 65 mg/100 ml caffeine content, a substantially brown color, and/or a particulate concentration of ≤10 mg/mL.

89. The method of claim 88, wherein the ratio of coffee beans to water are at a ratio other than 6% but the relationship of the ratio to total fat, saturated fat, polyunsaturated fat, polyphenol content, caffeine content, and/or a particulate concentration remains linear.

90. The method of any one of claims 88 and 89, wherein the water has a temperature of 0 to 25° C.

91. The method of any one of claims 88-90, wherein the coffee is brewed within 15 minutes.

92. The method of any one of claims 88 and 89, wherein the coffee is brewed within 15 minutes and the water has a temperature of 0 to 25° C.

93. The pod of any one of claims 1-13, wherein the pod comprises two or more filters with different pore sizes.

94. The pod of claims 93, wherein at least one of the filters has a pore size selected from or within the range of:
10 μm, 20 μm, 30 μm, 40 μm, 50 μm, 60 μm, 70 μm, 80 μm, 90 μm, or 100 μm;
10 μm-1,000 μm;
10-50 μm, 10-100 μm, 10-250 μm, 10-500 μm;
20-60 μm, 30-70 μm, 40-80 μm, 50-90 μm, 60-100 μm; or
100-200 μm, 200-300 μm, 300-400 μm, 400-500 μm, 500-600 μm, 600-700 μm, 700-800 μm, 800-900 μm, 900-1,000 μm.

95. The beverage brewing device of any one of claim 14-22 or 44-81, comprising the pod of any one of claim 93 or 94.

96. A beverage produced by the beverage brewing device of claim 95, wherein the beverage comprises coffee having at least 0.25% total fat, at least 0.1% saturated fat, at least 0.1% polyunsaturated fat, at least 140 mg/100 ml polyphenol content, at least 65 mg/100 ml caffeine content, a substantially brown color, and/or a particulate concentration of ≤10 mg/mL.
